(19) United States
(12) Patent Application Publication
(10) Pub. No.: US 2008/0235112 A1
(43) Pub. Date: Sep. 25, 2008

(54) Website, system for and method of providing marketing material for securities to authorized users & method of selling access to, including the right to copy and distribute copied marketing material

(76) Inventor: Peter Montoya, Tustin, CA (US)

Correspondence Address: CONNORS ASSOCIATES, 1600 DOVE ST, SUITE 220, NEWPORT BEACH, CA, 92660, US

(21) Appl. No.: 11/726,705

(22) Filed: Mar. 22, 2007

(51) Int. Cl. G06F 17/30

(52) U.S. Cl. 705/27

(57) ABSTRACT

A website on a computer network that includes an electronic library containing marketing material concerning securities that only an authorized user can access. The marketing material has been pre-approved as complying with regulations governing the sale of securities. Data concerning the marketing material is tracked to enable reporting in compliance with these regulations. The website enables uploading by a Registered Representative, or another author, who is an authorized user of unapproved marketing material for review and approval by a compliance officer of a registered Broker/Dealer of the Registered Representative who is also an authorized user. When approved, this marketing material submitted by the Registered Representative, or another author, can be accessed over the computer network by any authorized user or only a limited number of authorized users.

### INCORPORATION BY REFERENCE

Any and all U.S. patents, U.S. patent applications, and other documents, hard copy or electronic, cited or referred to in this application are incorporated herein by reference and made a part of this application.

### Definitions

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

The word “data” includes, but is not limited to, metadata, text such as, for example, marketing materials, alphanumerical characters, and any symbols.

The word “domain name owner” means a legal entity that has title to, or controls whether holding title or not, directly or indirectly, the use of a domain name.

The word “authorized user” is anyone who pays a subscription fee to gain access to the website disclosed herein, for example, any member of the public, a registered Broker/Dealer, a Registered Representative of a registered Broker/Dealer, an outside author, or any other person or legal entity.

### BACKGROUND

The sale of securities (as that word is commonly understood in the financial services industry), and anyone engaged in the business of selling securities, is governed by law. The Securities and Exchange Commission (SEC) is the Federal governmental agency charged with the responsibility of regulating the sale securities, in general, by registered Brokers/Dealers and their Registered Representatives (as these words are commonly understood in the financial services industry). The National Association of Securities Dealers (NASD), a voluntary association of persons and companies in the financial services industry, also promulgate regulations for their members.

A common requirement imposed by both the SEC and the NASD is that marketing material (a common phrase used in the financial services industry which includes, but is not limited to, client communications and sales and advertising literature) regularly assign a compliance officer the task of reviewing and approving marketing material and keeping adequate records conforming to certain regulatory standards. In this way the content of the marketing material, its date of approval and distribution to the marketplace, and other data is tracked, captured, sorted, and assembled into suitable reports to be provided during, or prior to, an audit. This is a monumental task. Because of the number of individual items of marketing material being reviewed and scrutinized and their varying individual content, there is imposed on registered Brokers/Dealers, and their Registered Representatives, excessively high operational costs to comply with the regulations. It is desirable to reduce these costs.

### SUMMARY

My website, system for and method of providing marketing material for securities to authorized users has one or more of the features depicted in the illustrative embodiment discussed in the section entitled “DETAILED DESCRIPTION OF ONE ILLUSTRATIVE EMBODIMENT.” The claims that follow define my invention; however, without limiting the scope of my invention as expressed by these claims, in general terms, some, but not necessarily all, of the features of my website, system, and methods are:

One, my system includes a computer network, for example, the public global computer network commonly referred to as the internet. My unique website, however, may be installed on either a public or private computer network, but most advantageously, it is installed on the internet. My website includes an electronic library containing marketing material concerning securities and client communications and it is identified by a domain name that enables anyone to access my website over the internet and pay a subscription fee to gain access to the contents of the library. Typically, the domain name owner controls the conditions of use by an authorized user through a legally binding contract. The marketing material may be approved prior to placing it on the website for distribution to the marketplace, for example, it may be reviewed by a compliance officer of a registered Broker/Dealer who is an authorized user. The approved marketing material is downloadable over the computer network. Only an authorized user can access the contents of the library and download the approved marketing material.

Two, in accordance with the instructions of a program that controls my website's operations, data is automatically collected, stored, sorted, and assembled into suitable reports to be provided in response to an audit. The program identifies (i) each individual item of approved marketing material stored in the library and when each such item is downloaded, (ii) the authorized user downloading each such item, (iii) the source approving the content of each such item, for example, the compliance officer who approved of an individual item and his or her registered Broker/Dealer who is an authorized user, (iv) the date of approval of each such item, (v) the nature of the contents of each such item, and (vi) when a Registered Representative who is an authorized user downloads any such individual item, that representative's registered Broker/Dealer who is also an authorized user. The branch manager of the registered Broker/Dealer, who is responsible for the Office of Supervisory Jurisdiction (Branch Manager/OSJ), may also have access to the reports. Any registered Broker/Dealer who is an authorized user, or their compliance officer, or their OSJ, may at any time over the computer network access the website and download a report. And like the report, a certificate of compliance may also be downloadable from the website by such a Broker/Dealer, or their compliance officer, or their Branch Manager/OSJ.

Three, in my system a Registered Representative who is an authorized user may submit any unapproved item of marketing material for review and approval by uploading the item to my website. Concurrently, this representative may notify the compliance officer of the representative's registered Broker/Dealer who is an authorized user that this unapproved item has been uploaded for review and approval. The compliance officer downloads this item, reviews and modifies it if required or prudent, and then uploads to my website the now approved item for storage in the electronic library. Alternately, the compliance officer of a registered Broker/Dealer who is an authorized user will periodically log onto my website and open a file in which are stored uploaded unapproved items from representatives requiring review and approval. Upon approval the item is stored in the electronic library. Notices may be sent by E-mail between the authorized Registered Representative and the compliance officer of the representative's authorized registered Broker/Dealer when items are submitted for approval and when an item is approved.

Four, if desired, any item in the library may be labeled so that it can be assessed by (a) any registered user or (b) only by a limited number of specifically identified registered users. Other conditions controlling access to the marketing material in the electronic library may be imposed. The approved marketing material may be stored electronically in a write once read many times form.

Five, outside authors can submit their works, which may be copyrighted, to the library on my website. Once approved and stored in the library, each individual Broker/Dealer may allow access of the author content to their Registered Representatives. The outside authors may also be paid for each time anyone accesses their work, and my system tracks downloading of the works of outside authors so they may be compensated financially. The Registered Representatives may request compliance review and their Broker/Dealer compliance officer may approve the content for that Registered Representative and other Registered Representatives as deemed appropriate by the compliance officer. The author must first become an authorized user by signing a suitable user agreement. He or she then submits content over the network and the compliance officer reviews and approves this marketing material for storage in their specific Broker/Dealer library. Registered Representatives of that Broker/Dealer may request individual author content to be approved, and approved marketing material may then be downloaded by Registered Representatives.

These features are not listed in any rank order nor is this list intended to be exhaustive.

There are at least two related methods disclosed herein. One of my methods provides online delivery of approved marketing material concerning the securities industry to authorized users. The other is a method of selling access to, including the right to copy and distribute, marketing material concerning the securities industry stored in an on-line electronic library containing this marketing material. Only those who have paid a subscription fee can gain access to the contents of the on-line electronic library. The subscription fee may be paid on-line. The contents of the electronic library is downloadable over the computer network by an authorized user for copying and distribution. Data concerning the marketing material and approval of and access to is tracked to enable reporting in compliance with regulations governing securities Brokers/Dealers and their Registered Representatives. The marketing material may be identified for distribution to a limited number of selected, individual authorized users. An individual Registered Representative who is an authorized user and a compliance officer of the registered Broker/Dealer of such representative who also is an authorized user may be in communication with each for reviewing marketing material for approval by the compliance officer prior to placing in the electronic library. The website may be programmed as discussed above to collect data as the individual authorized users download the marketing material and prepare a report based on the collected data that is suitable for submission in compliance with regulations governing securities brokers/dealers and their Registered Representatives. The report may be an electronic report downloadable from the website over the network. As discussed above, a Registered Representative who is an authorized user over the network may submit for approval by uploading to the website an unapproved item of marketing material that is in electronic form and downloadable from the website for review and approval, and subsequently uploaded to the website after approval.

The method of selling access to, including the right to make a copy of and distribute, pre-approved marketing material concerning the securities industry uses the website programmed as discussed above. This website has a domain name and domain name owner having the legal right to control who can download material from the website. The domain name owner enters into a legally binding agreement with a legally competent party so this party becomes an authorized user who can access the website over the network using an identifying access code.

### DESCRIPTION OF THE DRAWING

One embodiment of my novel and non-obvious website, system, and methods will now be discussed in detail in connection with the accompanying drawing, which is for illustrative purposes only. This drawing includes the following figures (Figs.), with like numerals indicating like parts:

FIG. 1 is a schematic diagram of one embodiment of my system.

FIG. 1A is a schematic diagram depicting of how marketing materials stored in an electronic library are accessed via my novel website.

FIG. 1B is a web page of one type of report provided by my system and methods.

FIG. 1C is a home page of my novel website.

FIG. 1D is the home page depicted in FIG. 1C that illustrates a notated newsletter sold through my website.

FIGS. 2 through 4 are web pages that a buyer uses to purchase access to the electronic library on my website.

FIG. 5 is a web page showing a partial listing of marketing materials contained in an electronic library on my website.

FIG. 5A is a web page showing a partial reprint of one of the items on the list shown in FIG. 5.

FIG. 6 is an example of a web page discussing features of my website of particular interest to financial advisors.

FIGS. 7 through 7D are different web pages used in connection with submitting unapproved marketing materials for review using my website, system and methods.

FIG. 8 is a support web page discussing features of my website, system and methods and provides information for, and answers questions of, authorized users of my website, system and methods.

FIG. 9 is a web page discussing a privacy policy that may be followed in connection with personal information provided by subscribers using my website, system and methods.

FIGS. 10A through 10K are diagrams depicting a program used to operate my website.

### DETAILED DESCRIPTION OF ONE ILLUSTRATIVE EMBODIMENT

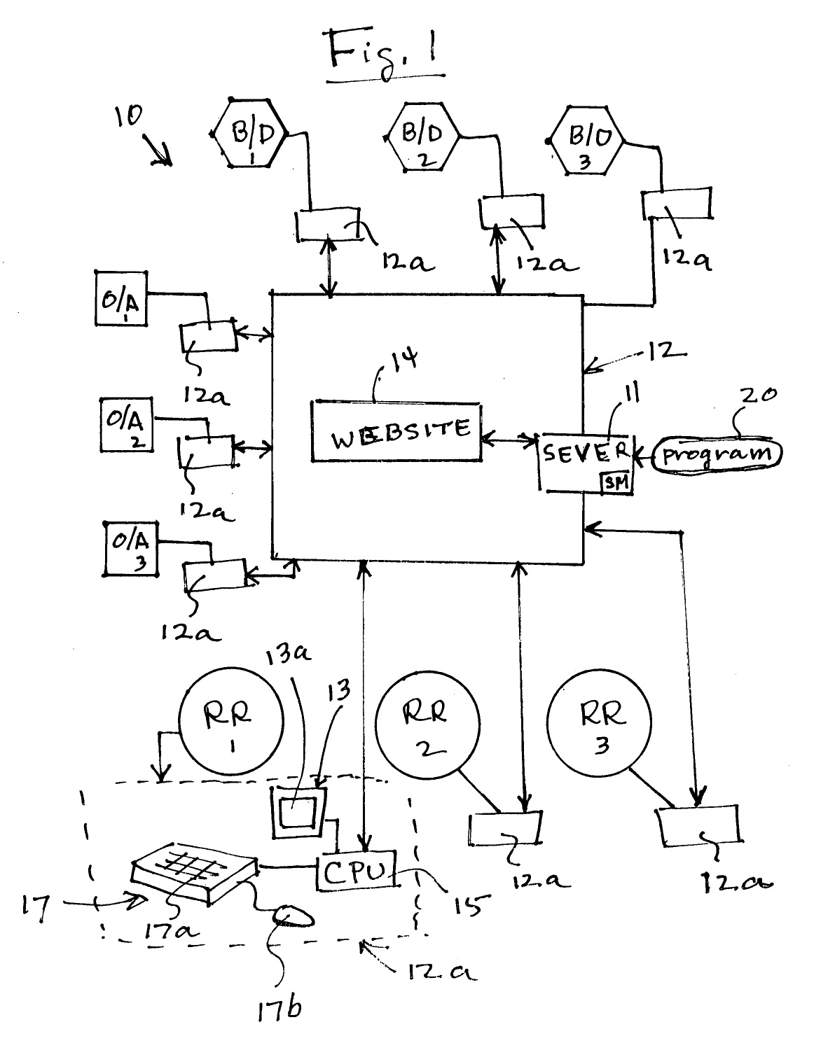

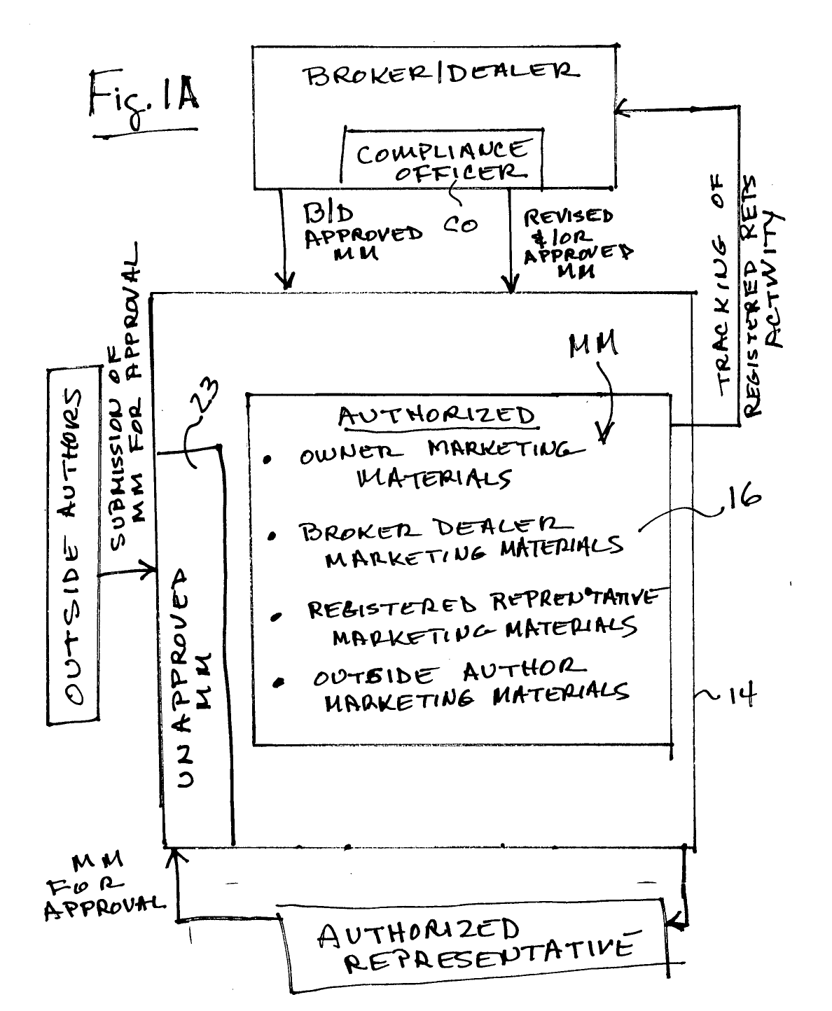

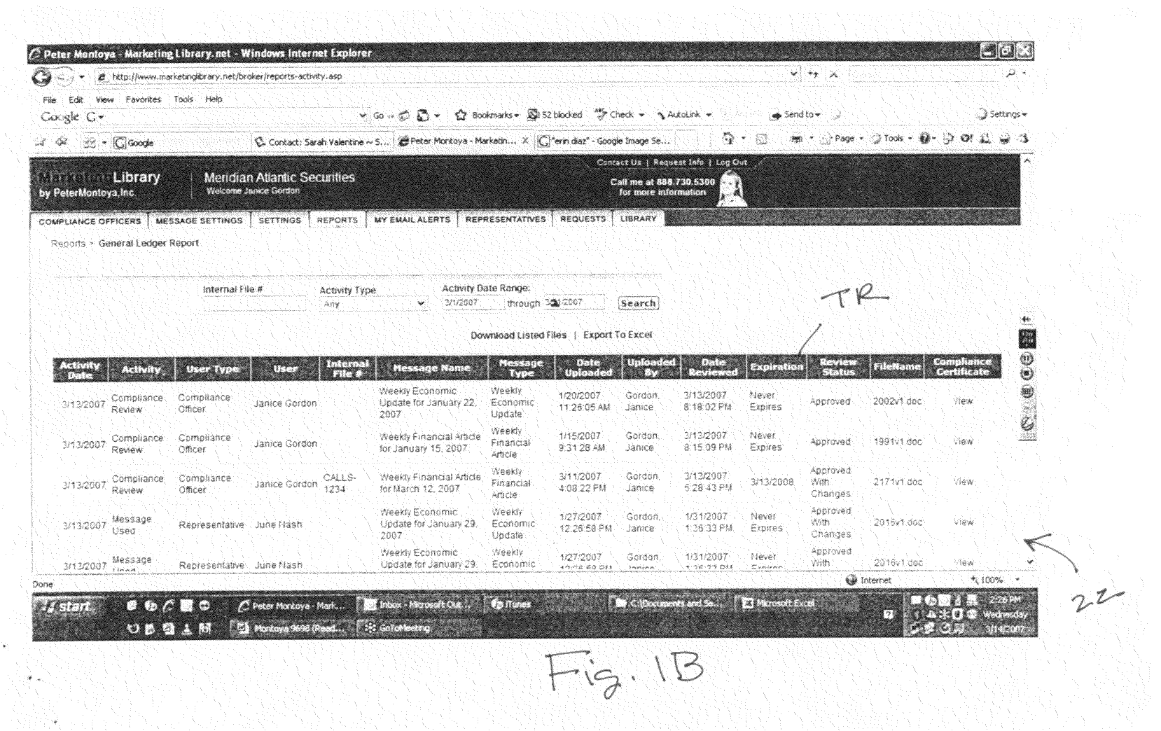

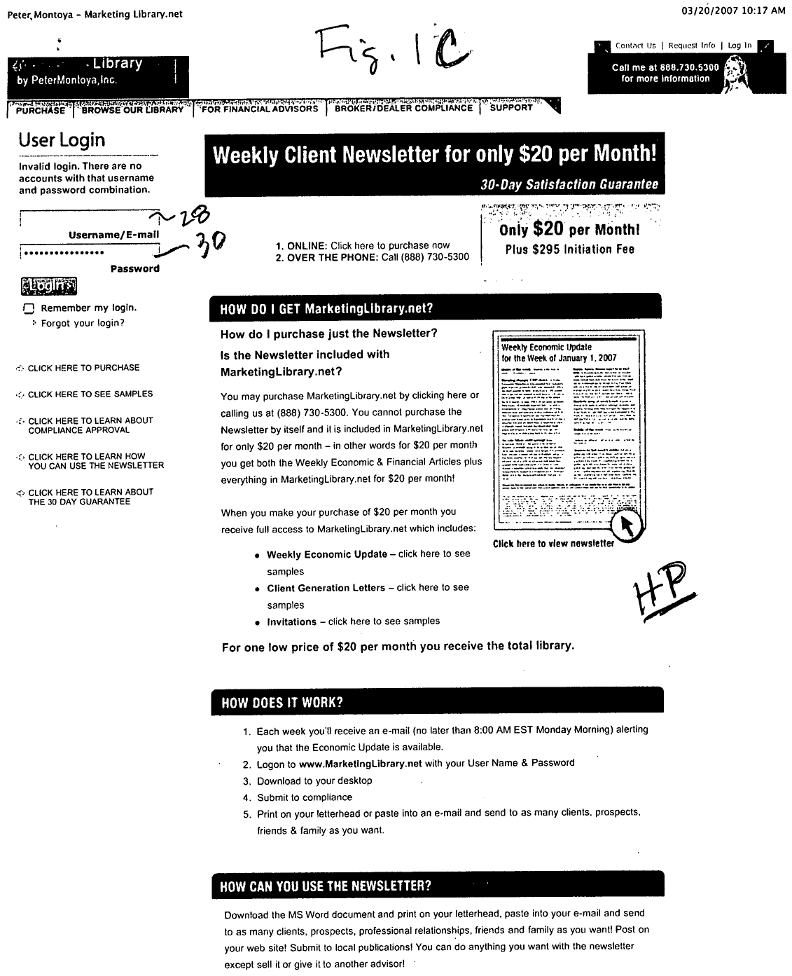

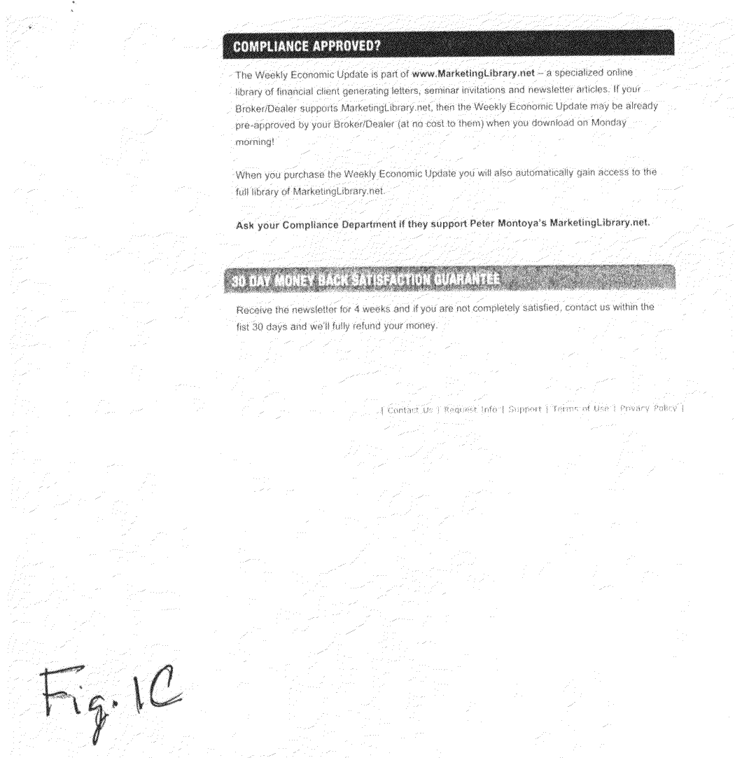

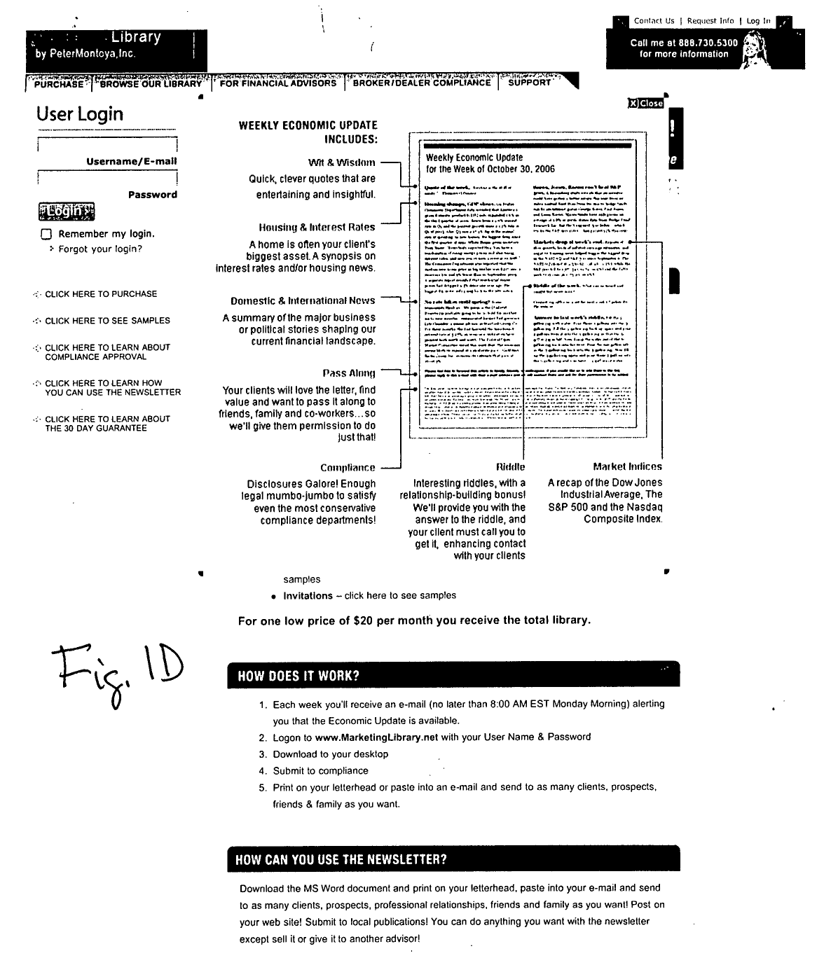

One embodiment of my website, system for and methods of providing over a computer network approved marketing material MM (FIG. 1A) concerning the securities industry to authorized users is illustrated in FIG. 1 and generally designated by the numeral 10. For example, the authorized users may be registered securities Brokers/Dealers B/D and their individual Registered Representatives RR, each of whom, in accordance with my selling method, have purchased access to the marketing material MM. My system 10 includes a computer network, for example, a public global computer network 12 commonly referred to as the internet.

FIG. 1A illustrates an example of my website 14 accessible over the network 12 by authorized users who have entered into legally binding agreements with the owner of the domain name of the website 14. The domain name provides an address on the internet 12 for the website 14. An example of a domain name for my website that is active at the time of filing this patent application and that is used in my system and methods is www.MarketingLibrary.net. This active website at the address of www.MarketingLibrary.net is incorporated herein and made a part of this patent application.

The website 14 includes an electronic library 16 (FIG. 1A) containing marketing material MM approved by a compliance officer CO of the authorized securities Broker/Dealer B/D of each individual authorized Registered Representative RR accessing the approved marketing material MM. The marketing material MM is stored electronically in the memory SM of a server 11 (FIG. 1) on the network 12. It is backed up weekly, for example, in a write once read many times (WORM) form. Consequently, the history of the approved marketing material MM is retained and unaltered. Thus, an auditor may review what marketing material MM was being distributed on what dates. This history cannot be changed after it has been approved by a compliance officer CO of an authorized securities Broker/Dealer B/D. There may be several different categories of approved marketing materials MM on the web site 14: CAT I-Domain Name Owner created and approved content, CAT II-Broker/Dealer created and approved content, CAT III-Third Party, for example, an outside author O/A, created and approved content, and CAT IV-Registered Representative created and approved content. Unless any specific item in the library 16 (FIG. 1A) is only for use by certain authorized users, any authorized user may access, copy and distribute any of the approved marketing materials MM on the website 14 to any anyone else. Registered Representatives RR may distribute copies to current or prospective clients.

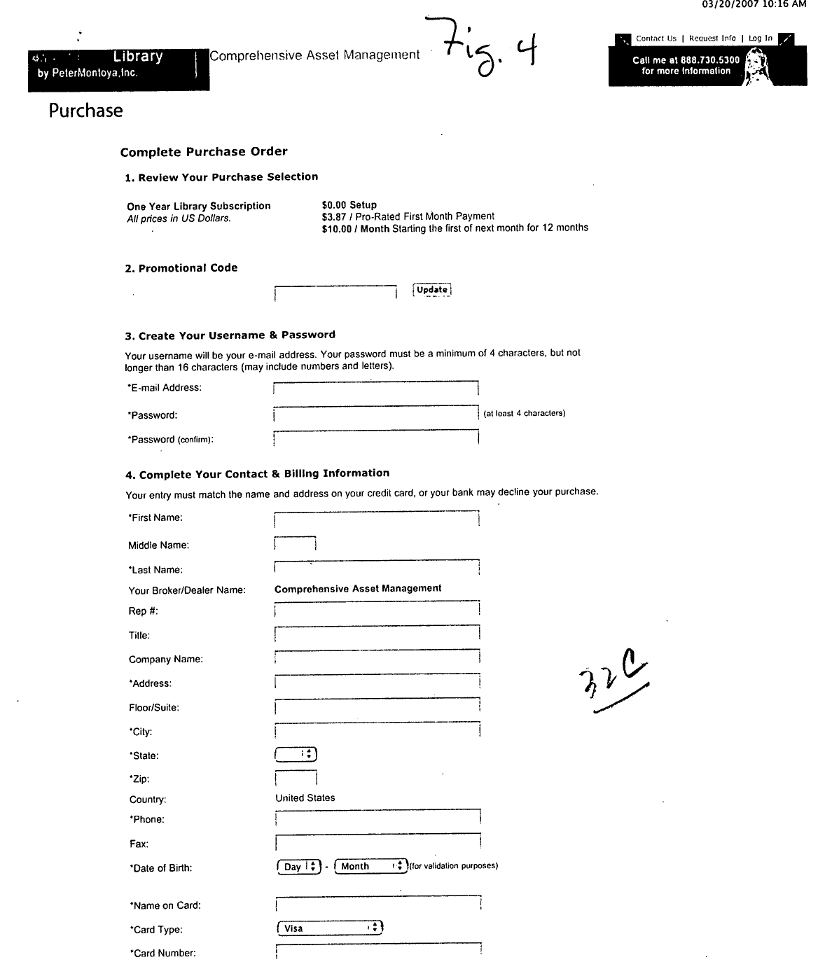

A suitable report or reports as required to comply with regulations governing securities Brokers/Dealers and their Registered Representatives are generated using my website, system and methods. FIG. 1B is an example of a typical report, which in this case is one that an authorized Broker/Dealer or their compliance officer may create by interacting with the website 14 and view or download or both. This report shown in FIG. 3 lists events or activities from Mar. 1, 2007 through Mar. 21, 2007. Each row corresponds to an event, except a top row TR that serves as a column headings, with each heading identifying the types of data being associated an event. As discussed in greater detail hereafter, an authorized user by activating an individual link commands a program 20 to create a suitable report as determined by the authorized user. For example, by pointing and clicking on an interactive button IB using a mouse 17b (FIG. 1) there is displayed a report in electronic form on a computer screen 13a (FIG. 1) of the user's computer system. This report can be downloaded, printed or otherwise copied. The program 20 operates the website 14 to track electronically data needed to provide the reports. Specifically, the program 20 identifies (i) each individual item of approved marketing material stored in the library and when each copy of such item is downloaded, (ii) the authorized user downloading each copy of such item, (iii) the source approving the content of each copy of such item, for example, the compliance officer who approved of an individual item and his or her registered Broker/Dealer who is an authorized user, (iv) the date of approval of each such item, (v) the nature of the contents of each such item, and (vi) when a Registered Representative who is an authorized user downloads any copy of such individual item, that representative's registered Broker/Dealer who is also an authorized user. As authorized users interact with the website 14 this identifying data is collected and stored electronically, for example, in the memory SM of the server 11.

Each authorized user signs a legally binding agreement prior to being given access to the contents of the electronic library. Periodically, or on command, an electronic report based on the collected data is prepared and, over the network 12, may be accessed by an authorized user such as, for example, a compliance officer, Branch Manager/OSJ, or other personnel of an authorized securities Broker/Dealer B/D. The report 22 may, for example, be created using any suitable application software such as, for example, Microsoft EXCEL spreadsheet.

To access the website 14 the domain name owner and authorized user enter into a legally binding agreement that gives the authorized user the right to access the contents of the electronic library 16, download a copy, and, if the authorized user chooses, to distribute the copy. Other standard terms and conditions such as, for example, a termination provision, are typically included in an agreement. An example of a suitable agreement (the Agreement I) between a securities Broker/Dealer and a domain name owner is attached as Appendix I. An example of a suitable agreement (the Agreement II) between a Registered Representative and a domain name owner is attached as Appendix II. Usually, individual authorized Registered Representatives will sign the Agreement II electronically through accessing the website 14 as discussed subsequently herein.

Any authorized user connects to the computer network 12 by a telephone line, DSL line, wireless or other means through his or her computer system 12a. For example, an authorized Registered Representative RR selects as desired individual items from a listing (FIG. 5) of previously approved marketing material MM. FIG. 5 is a listing of interactive links to samples of marketing materials MM. An authorized user by pointing and clicking on an individual link displays the item of marketing material MM on the screen 13a and can print or otherwise copy it. A compliance officer CO, or other authorized personnel of an authorized securities Broker/Dealer B/D, accessing the website 14 over the network 12 downloads the reports (FIG. 1B) in which the data is assembled automatically as it is collected. Typically these computer systems 12a (only one shown) include a monitor 13, a central processing unit 15 having a suitable operating system (not shown), and input/output devices 17 such as a keyboard 17a and mouse 17b for pointing and clicking.

The following discloses how authorized users such as, for example, Registered Representatives RR and compliance officers CO interact with the website 14. As shown in FIG. 1C when an individual accesses the website 14 using the domain name address, for example, www.MarketingLibrary.net, a home page HP is displayed on a screen 13a of a monitor 13 of a computer system 12a. If the individual is a representative of an authorized Broker/Dealer B/D and has already purchased access to the website 14, he or she identifies himself or herself by typing in a user name or E-mail address and password in the fields 28 and 30, respectively, on the home page HP. This individual will now have access to all the pages of the website 14 including the approved marketing material MM in the electronic library 16.

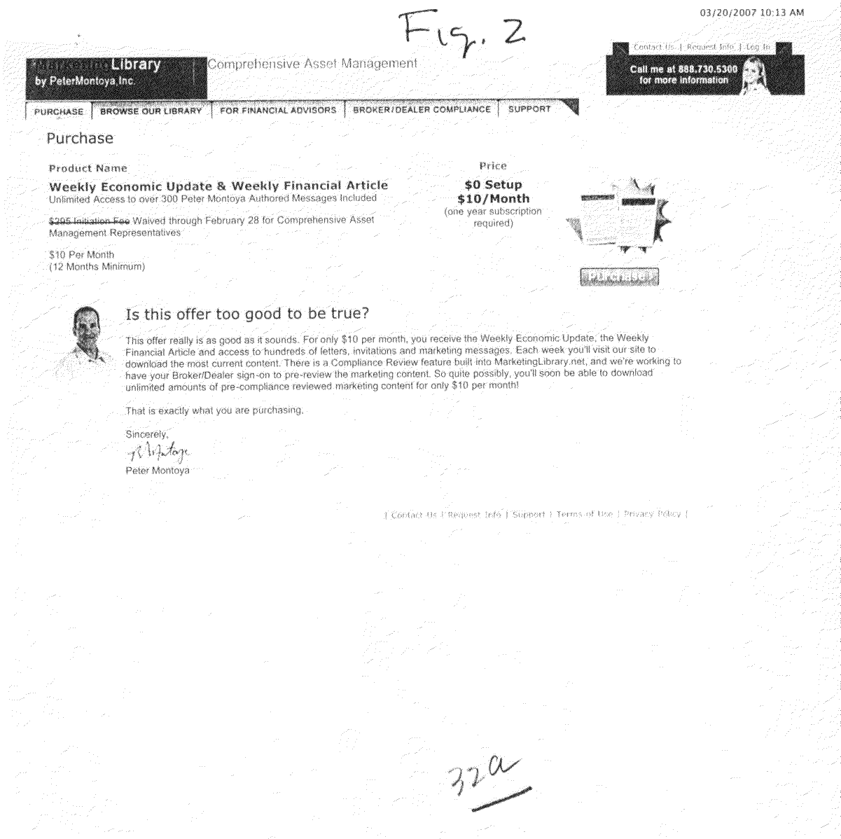

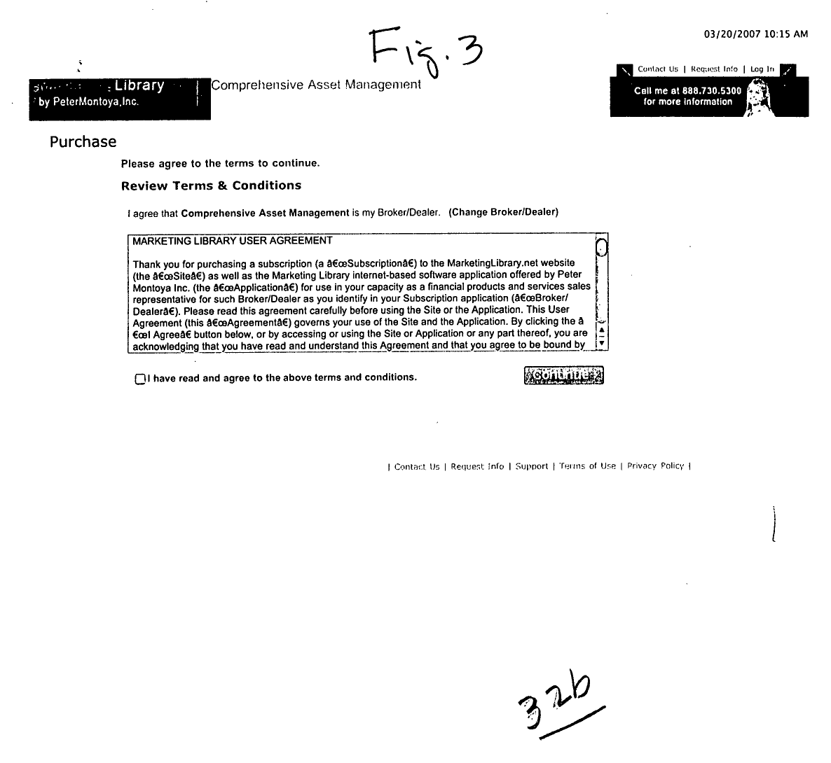

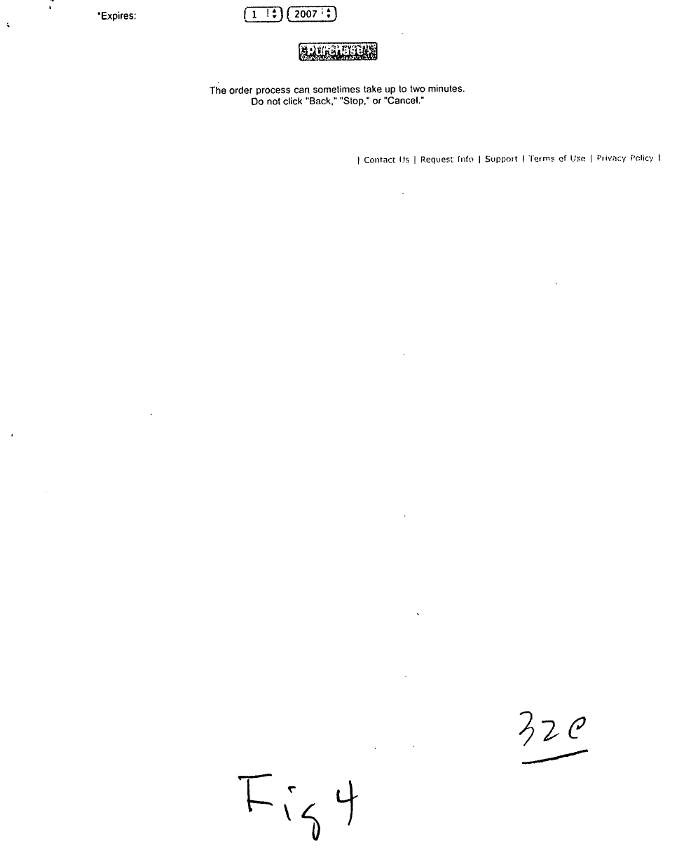

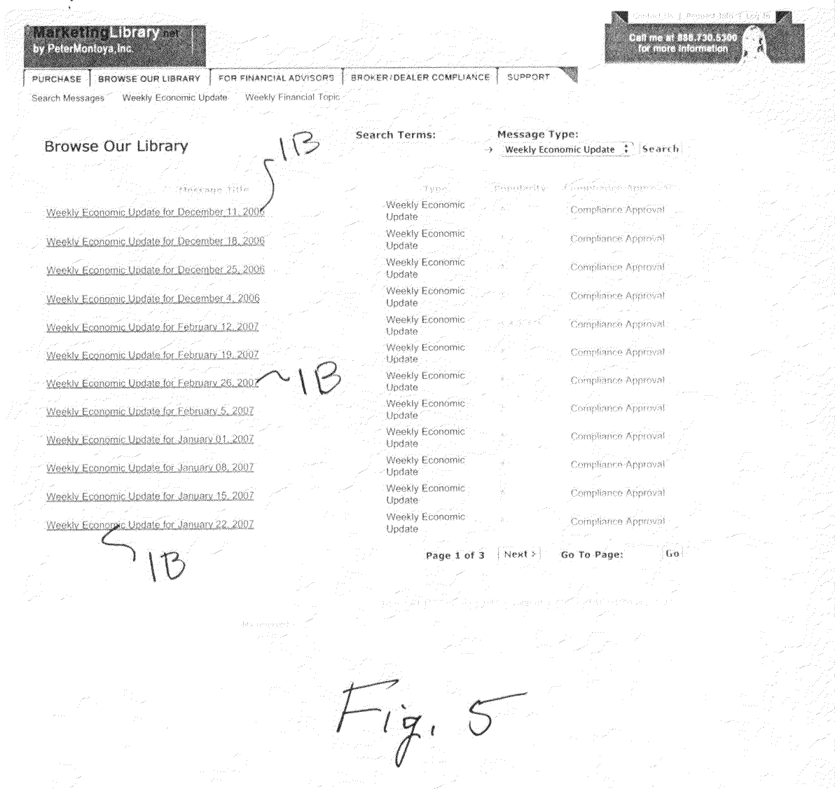

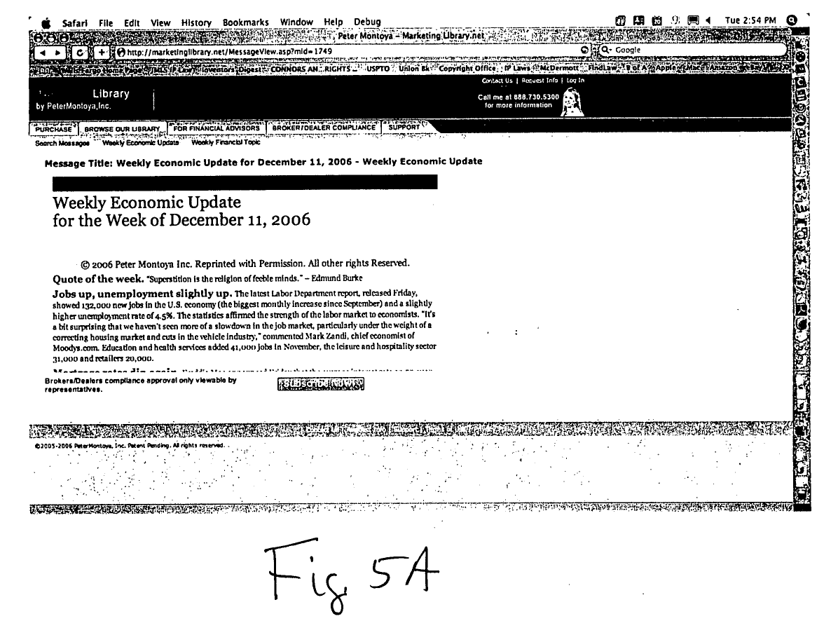

Along the top of the home page HP are a series of menu bars identified as “PURCHASE,” “BROWSE OUR LIBRARY,” “FOR FINANCIAL ADVISORS,” “BROKER/DEALER COMPLIANCE,” and “SUPPORT.” Clicking these bars brings one to various web pages as discussed subsequently. There are also along the left hand side of many of these web pages buttons including the word “CLICK,” indicating that these buttons are activated by pointing and clocking. For example, if an individual accesses the website 14 for the first time and desires to purchase the right to access, copy, download and distribute the contents of the library 16, he or she using the mouse 17b points to the button B1 (FIG. 1C) adjacent the phrase “CLICK HERE TO PURCHASE” or the menu bar labeled “PURCHASE.” Pointing and clicking activates and displays on the screen 13a in the conventional manner web pages 32a, 32b, and 32c, respectively shown in FIGS. 2, 3, and 4. These pages 32a, 32b, and 32c include active fields for the new authorized user to fill in the requested information indicated and pay by credit card.

Upon entering into an agreement (FIG. 3) with the domain name owner by checking the box entitled “I have read and agree to the above terms and conditions,” the authorized user such as, for example, authorized Registered Representative or outside author O/A, can download approved marketing materials MM, including a weekly newsletter provided, for example, by the domain name owner and illustrated in greater detail in FIG. 5A, and/or the various types of marketing materials MM falling into CAT I, CAT II, CAT III, and/or CAT IV. Promotional products and gifts such as, for example, invitations to the Antiques Road Show may be also offered to the authorized Registered Representative for distribution to prospective clients or others.

Pointing to and clicking the “BROWSE OUR LIBRARY” menu bar displays on a screen 13a a listing of different items of approved marketing materials MM (only page 1 of this listing is shown in FIG. 5). By pointing and clicking on an individual item listed, for example, by pointing and clicking on the item entitled “Weekly Economic Update for Dec. 11, 2006,” the activated listed item is displayed on the screen 13a. The text of this activated listing may be highlighted using the input/output devices 17, copied and transferred to an Email. Alternately, another document may be created by the individual authorized user. Each individual listing corresponds to a single item of the approved marketing material MM stored electronically, for example, in the memory SM.

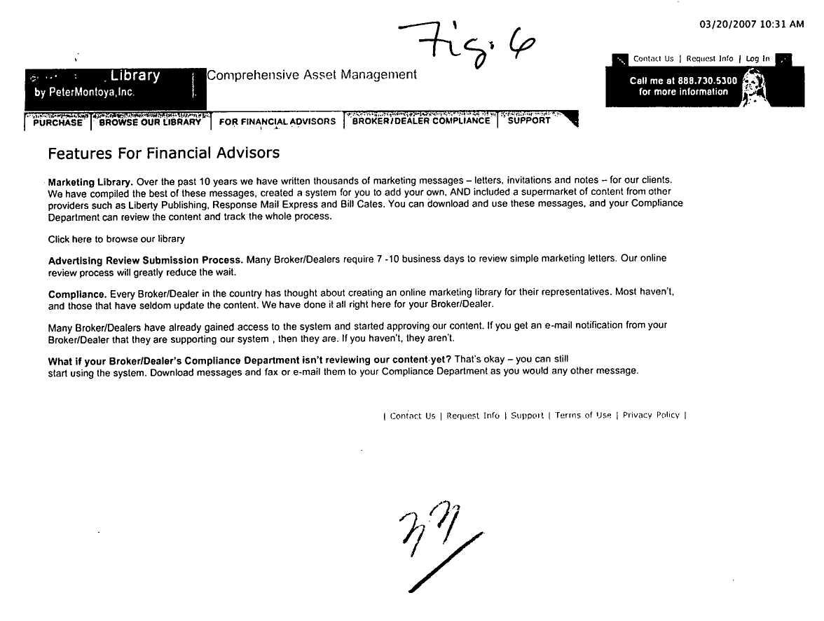

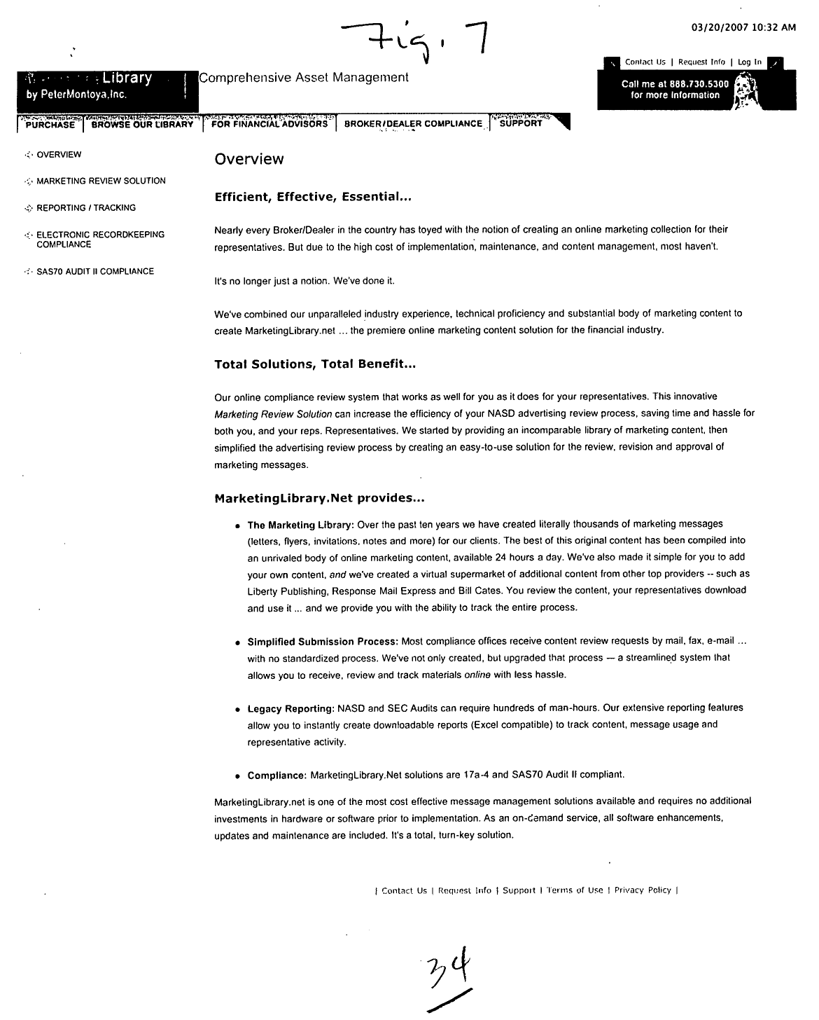

Pointing to and clicking the FOR FINANCIAL ADVISORS menu bar displays on a screen 13a the web page 33 shown in FIG. 6 that explains, among other things, the source of the listed items in the library 16 and includes an electronic link to the library. This web page also explains the marketing materials submission process.

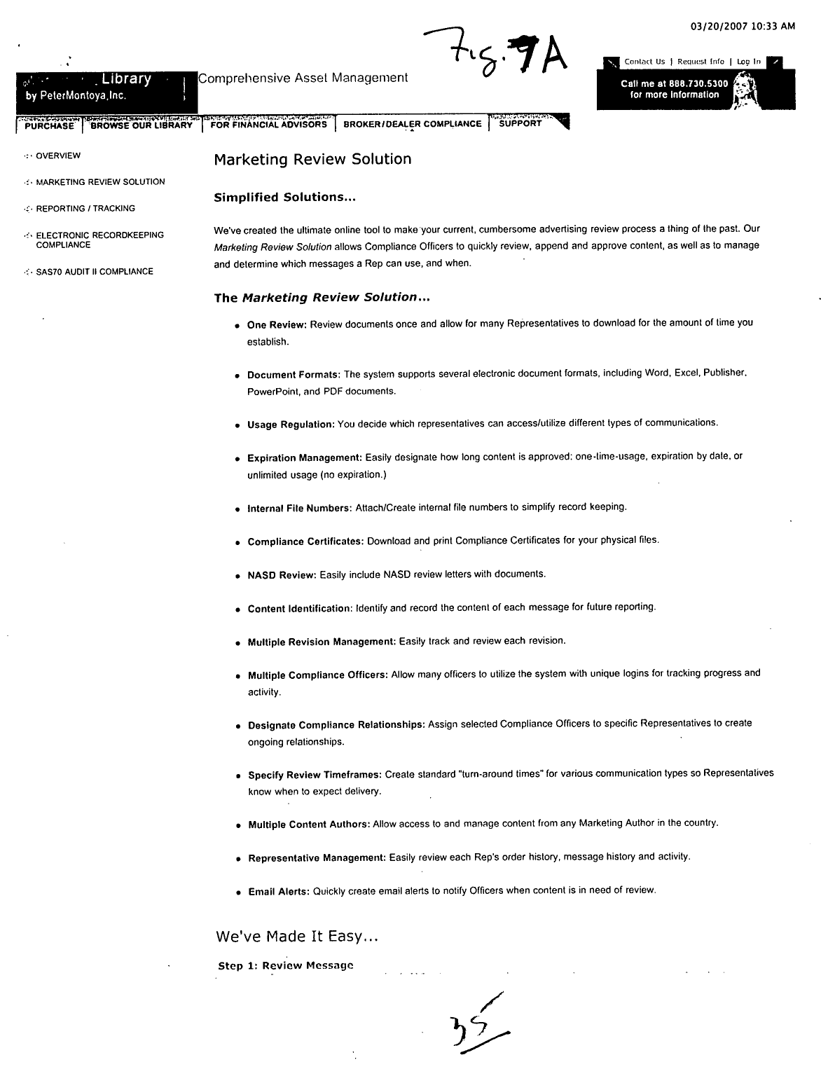

Pointing to and clicking the BROKER/DEALER COMPLIANCE tab displays on a screen 13a the web page 34 shown in FIG. 7. Pointing to and clicking the buttons along the left side of web page 34 respectively displays the web pages 35 (FIG. 7A), 36 (FIG. 7B), 37 (FIG. 7C), and 38 (FIG. 7D). This section of the website 14 enables an individual authorized Registered Representative to upload unapproved marketing materials UMM for compliance approval. An authorized Broker/Dealer B/D can download and print a compliance certificate that may be stored in the Broker/Dealer's hard copy, physical files.

Not only is approved marketing material MM downloadable, but unapproved marketing material UMM may be submitted over the network 12 via the website 14 for review and approval. An authorized Registered Representative RR or outside author O/A can submit from time to time unapproved marketing material UMM to the compliance officer CO of the representative's authorized Broker/Dealer B/D for review and approval. When approved by the compliance officer CO, this marketing material MM is stored in the electronic library 16. This marketing material MM may be used exclusively by the authorized Registered Representatives RR that originally submitted it for approval or by any authorized user as determined by authorized Broker/Dealer B/D.

As shown in FIG. 7A sheets 1 through 3 unapproved marketing material UMM is uploaded by a Registered Representative to a file 23 (FIG. 1A) on the website 14 and the compliance officer CO of this Registered Representative's authorized Broker/Dealer B/D reviews and may revise the unapproved marketing material UMM. An expiration date, usage rights, and content may be established by completing a field to provide the request information, clicking an appropriate box, or both. The unapproved marketing material UMM may be written using any suitable application software program such as, for example, Microsoft WORD, and the compliance officer CO may revise this unapproved marketing material UMM using the same software or an alternate compatible software program to modify the unapproved marketing material UMM so that it meets current legal or other requirements.

This revised and approved marketing material RMM is then uploaded to the website 14 by the compliance officer and stored in the library 16. An E-mail may be sent by the authorized Registered Representative RR to the compliance officer CO of his or her authorized Broker/Dealer B/D when unapproved marketing material UMM has been uploaded to the website 14 for approval (and possible revision), and an E-mail may be sent by the compliance officer CO to the authorized Registered Representative RR when the submitted, and now approved marketing material MM, has been uploaded to the website for use by the Registered Representative.

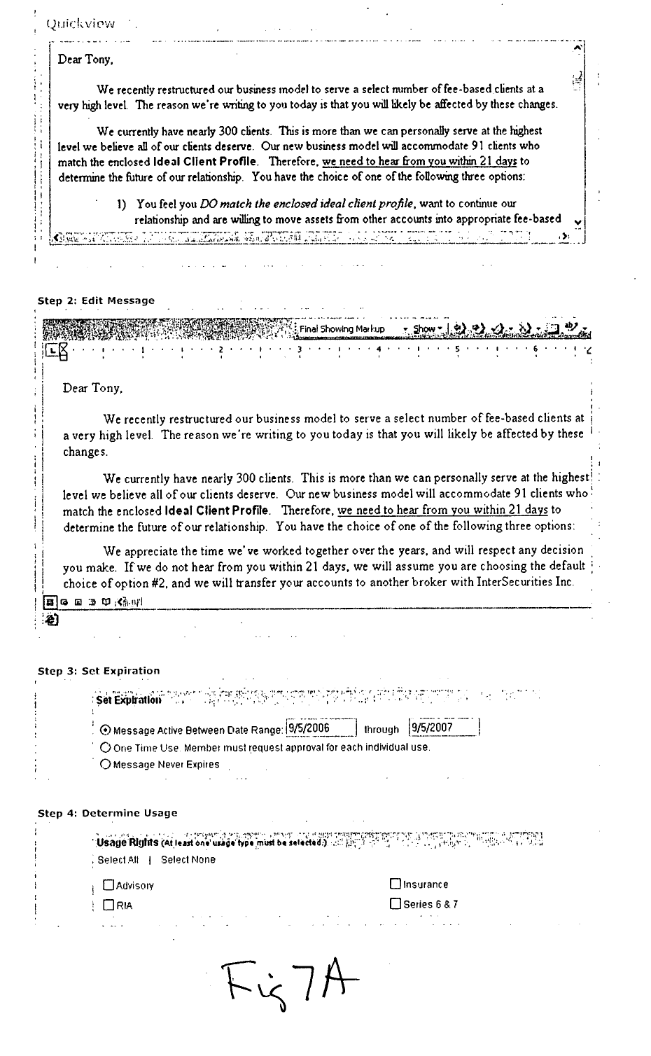

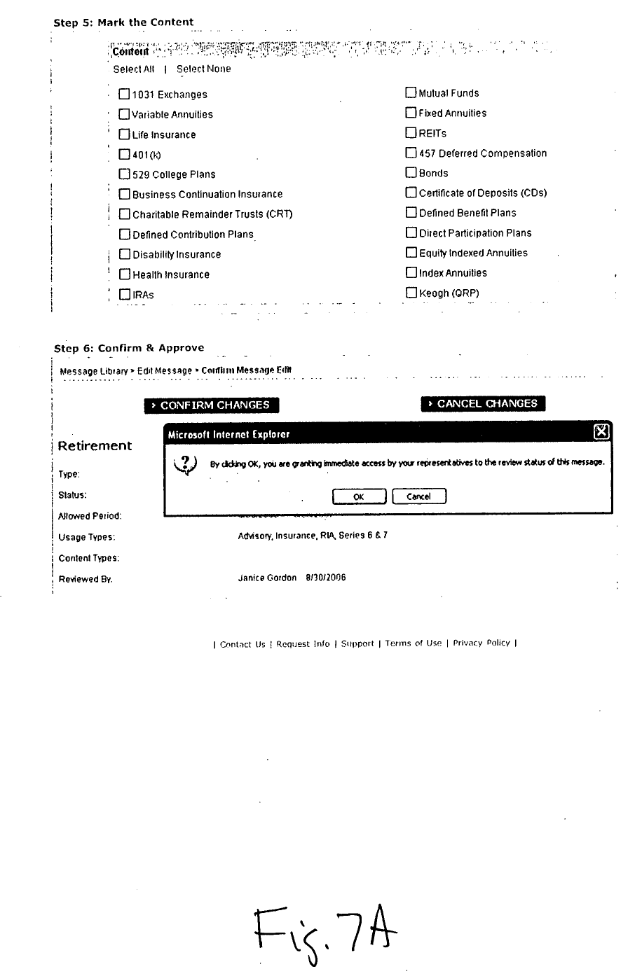

Pointing to and clicking the SUPPORT menu bar displays on a screen 13a the web page shown in FIG. 8. Authorized users will have many of their questions about my system and methods answered by the information on this web page and can obtain assistance from technicians that can assist them over the telephone or through E-mail by logging in as indicated.

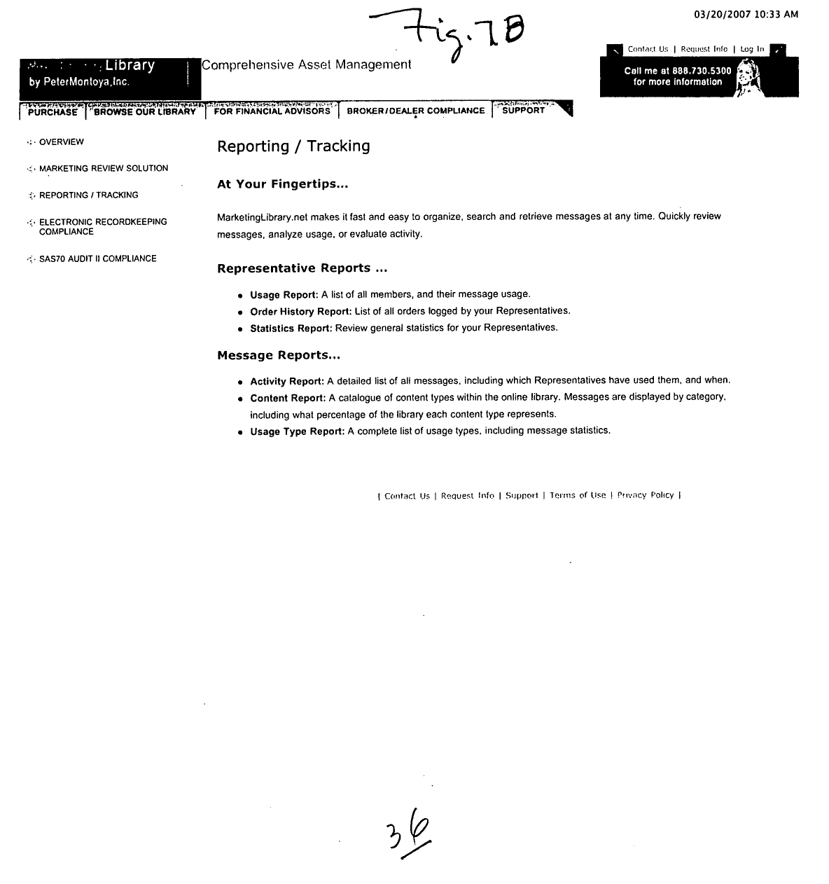

FIG. 9 shows a web page discussing a privacy policy that may be followed when conducting business online over the computer network 12 using my system 10.

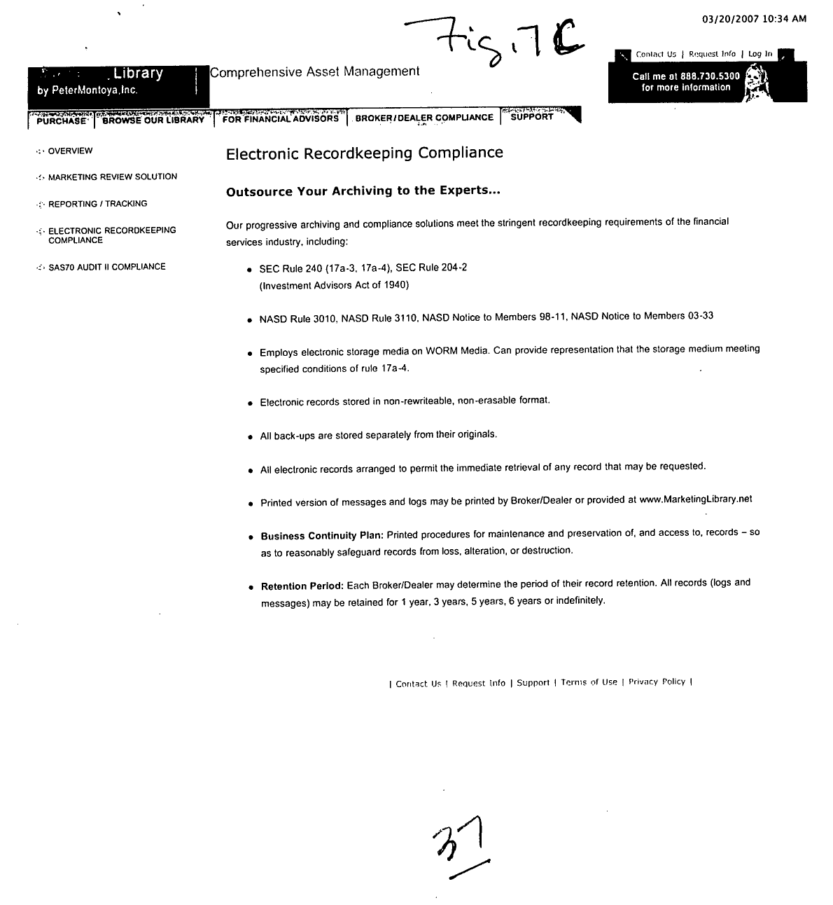

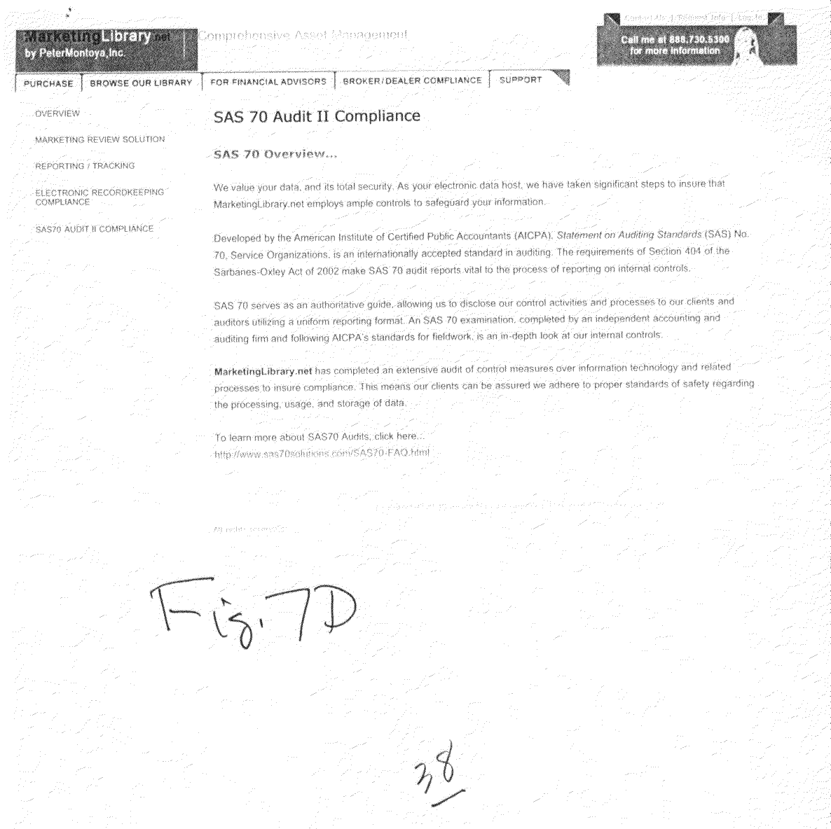

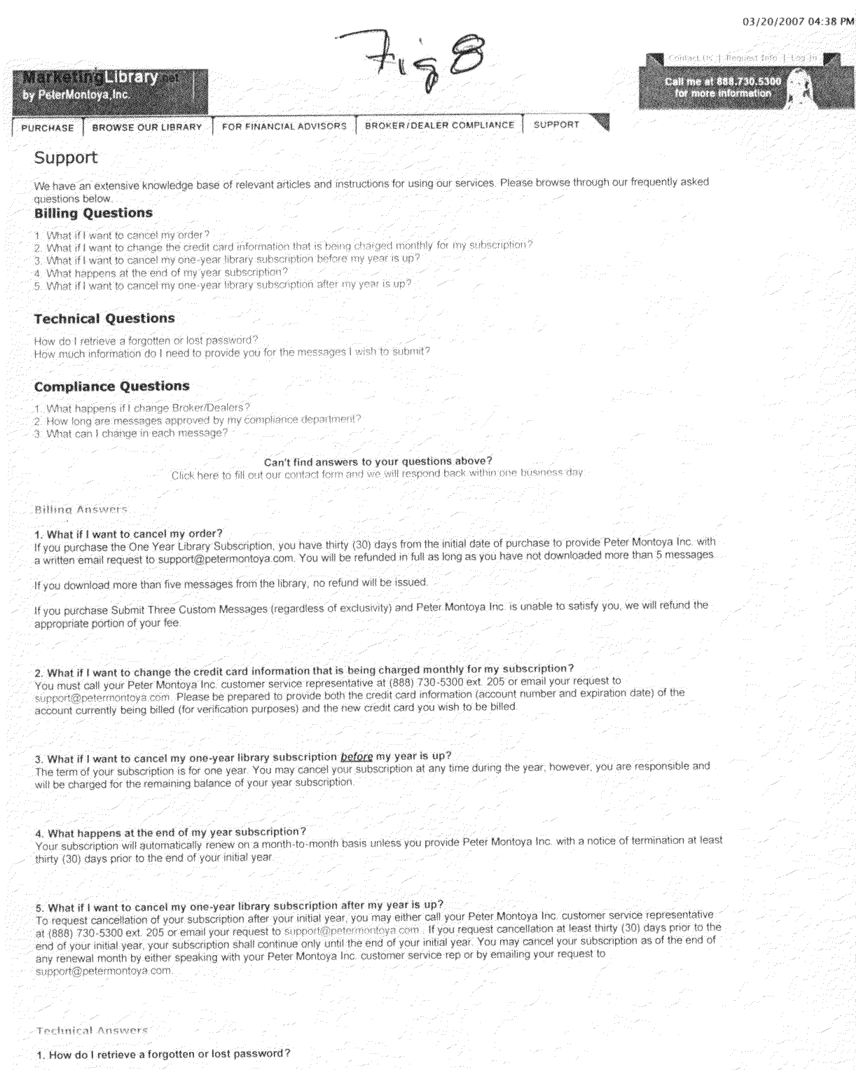

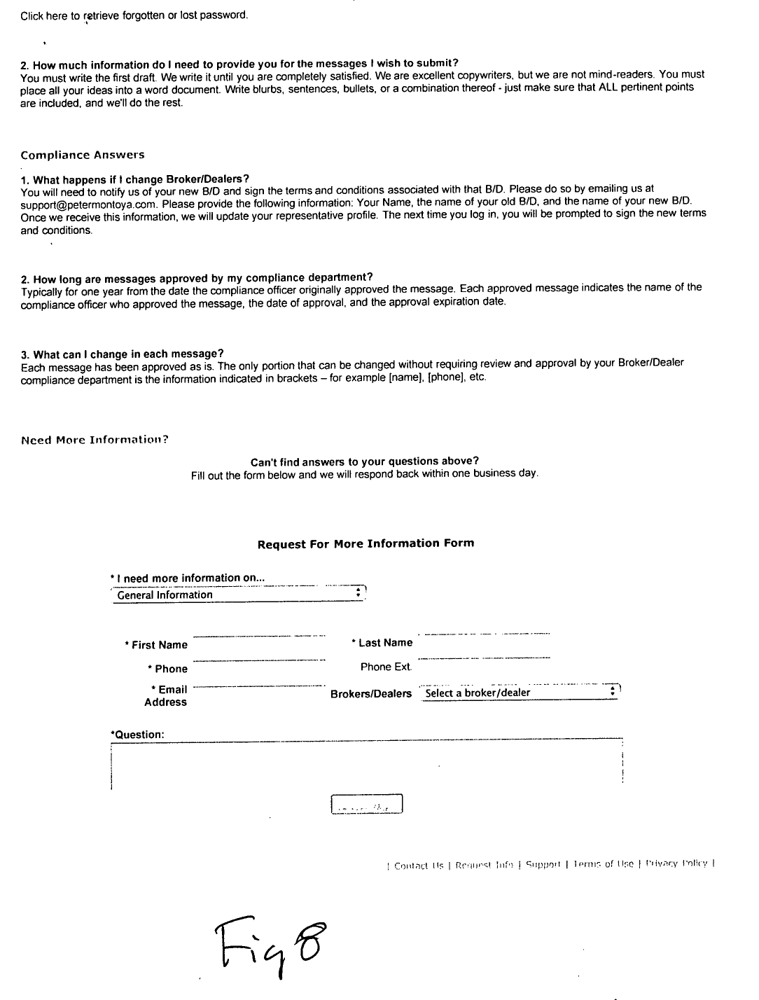

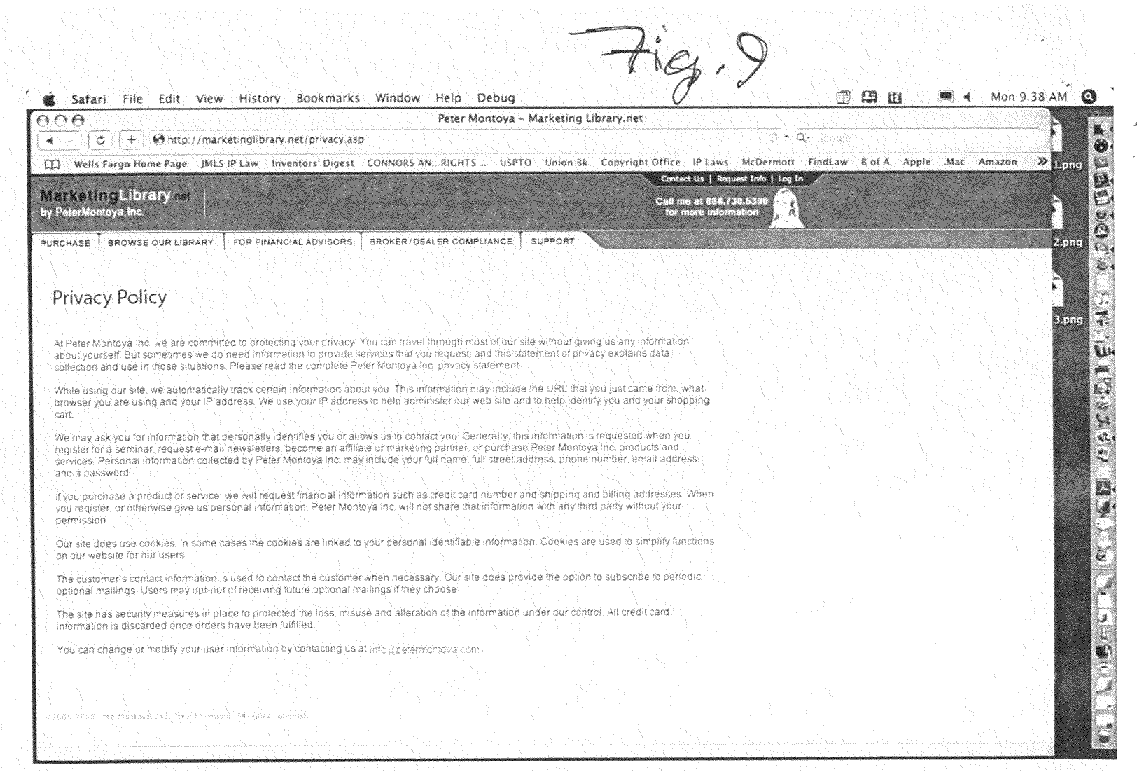

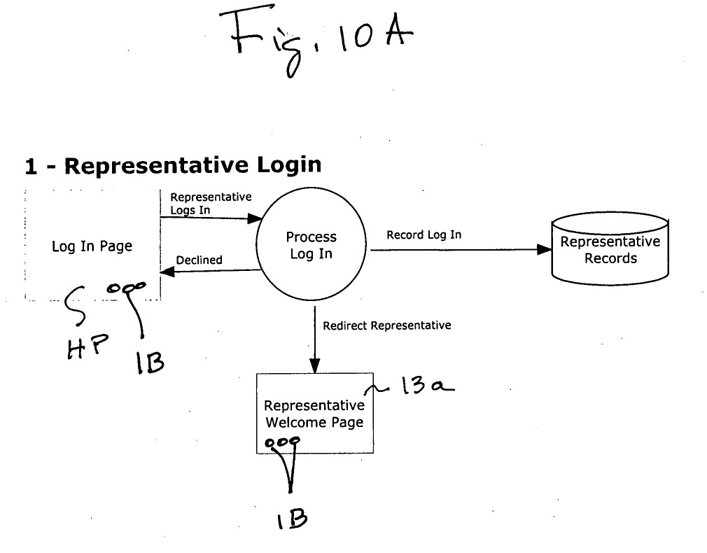

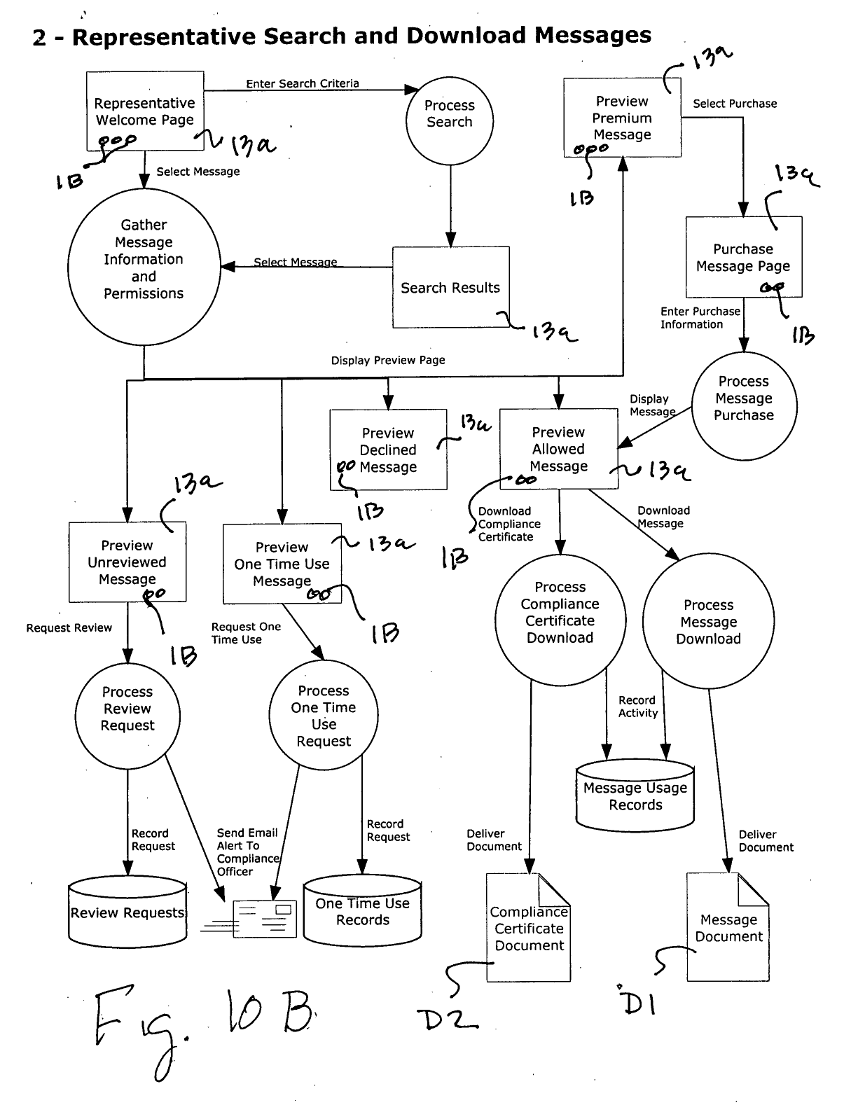

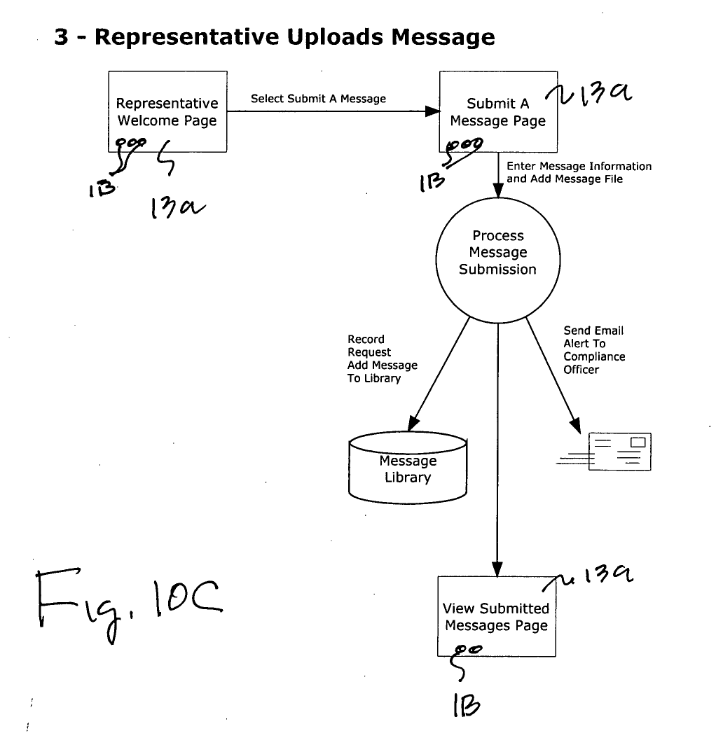

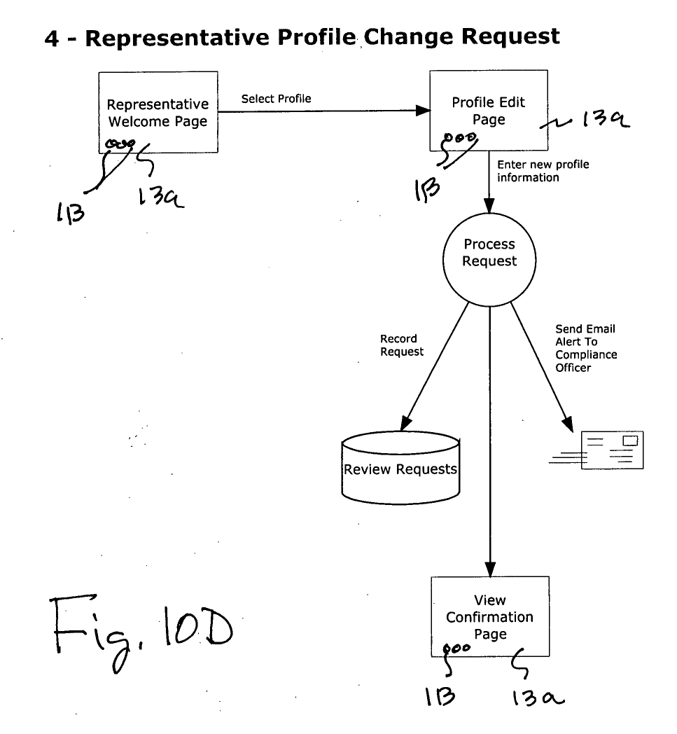

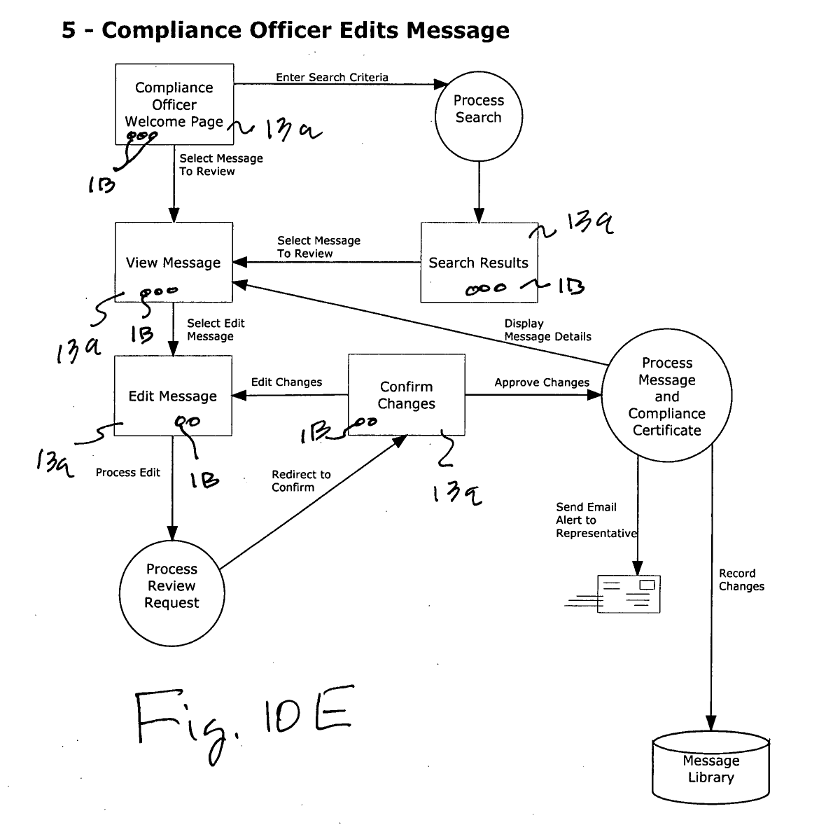

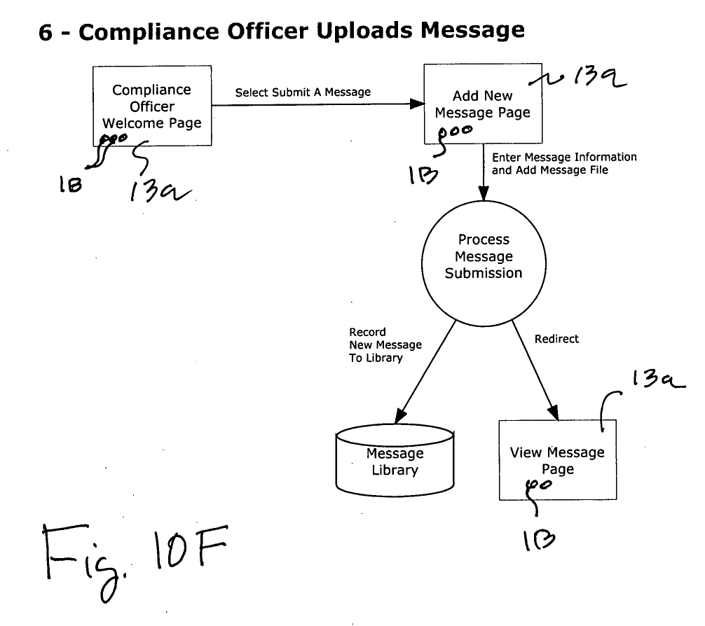

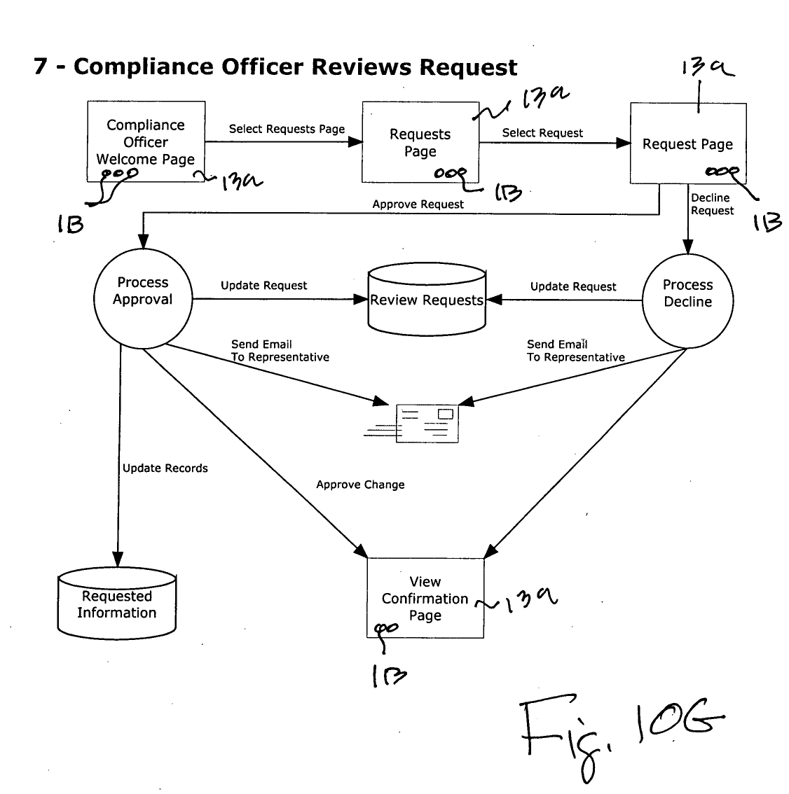

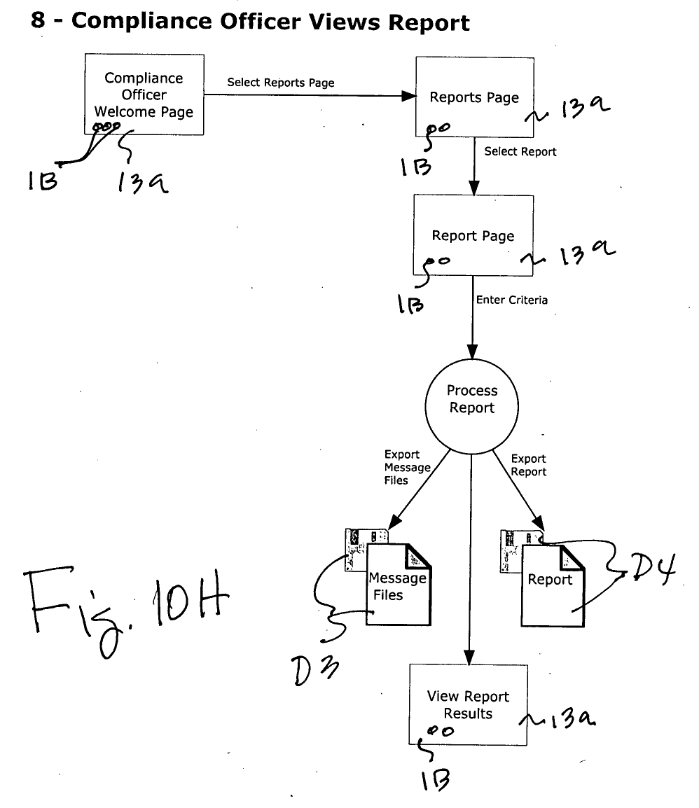

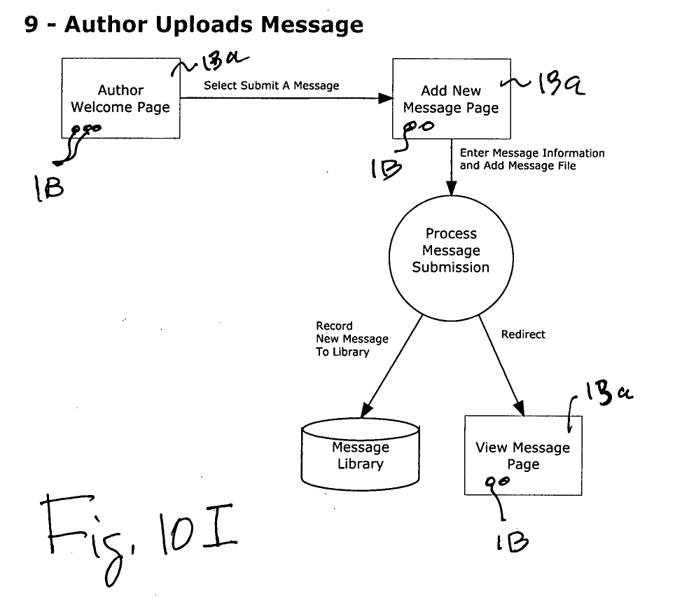

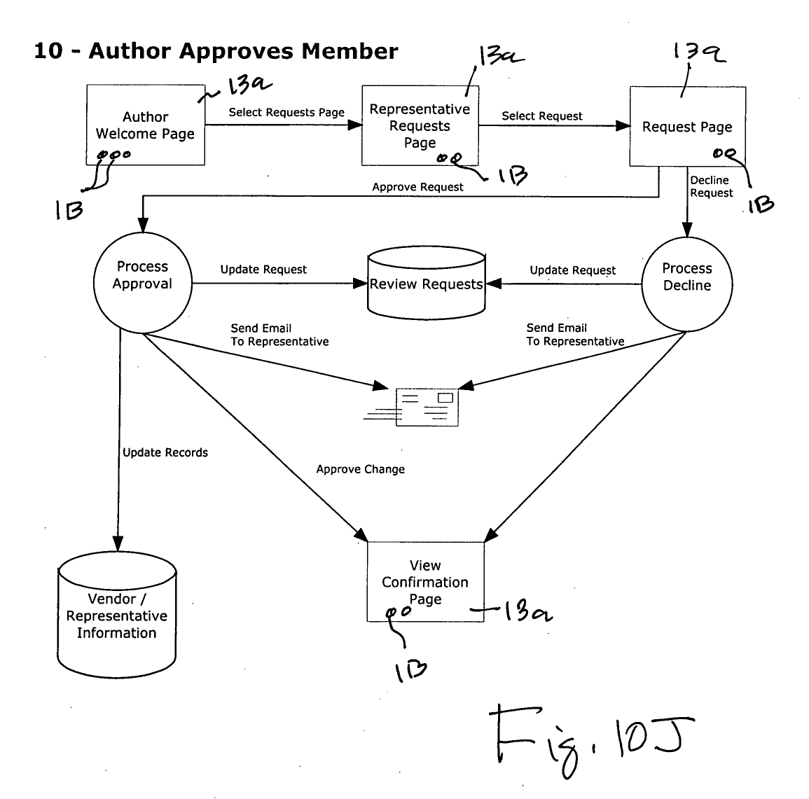

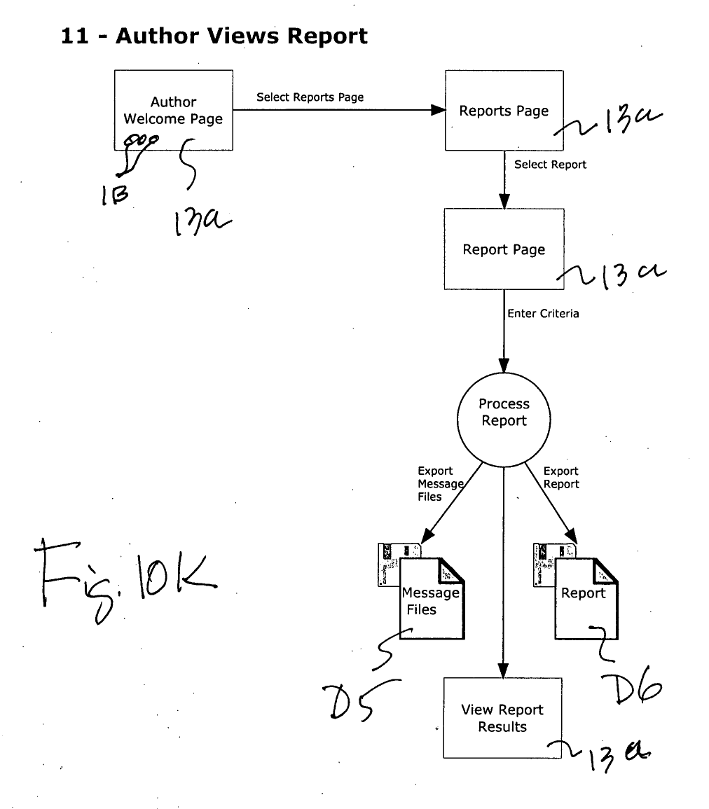

As illustrated in FIGS. 10A through 10K, program 20 functions to insure that only authorized users may access the approved marketing materials MM or submit unapproved marketing materials UMM for approval or obtain certain reports or otherwise interact with the website 14. The program 20 tracks events as an authorized user interacts with the website 14 and stores data associated with each event in a computer memory, typically the server memory SM. On command of an authorized user, the program 20 recalls from this memory identified data according to selected criteria to prepare a particular reported requested by the authorized user.

An example of one embodiment of the program 20 is depicted by the diagrams in the FIGS. 10A through 10K, where the symbols in the are as follows:

Rectangles are messages appearing on the screen 13a and include interactive buttons IB that by pointing to and clicking sends to the program 20 a command as indicated by an arrow.

Circles indicate that the program executes a process that is identified within the circle, and as indicated by an arrow from an individual circle (a) displays the result of the process on the screen 13a or (b) forwards data to a computer memory or (c) downloads a document or (d) sends Email alerts.

Cylinders indicate a computer memory that stores the data that is identified within an individual cylinder.

Postcards Indicate an Email.

As illustrated in the diagram of FIG. 10A, when, for example, a Registered Representative RR logs in through the home page HP using his or her name and password as discussed above, the program 20 first determines if this Registered Representative has purchased a subscription and is currently an authorized user. If not, access to the website 14 and library 16 is declined. Each time an authorized user logs in his or her identity and date of the login is collected and this data is stored in the memory SM and identified, for example, as “Representative Records” when the user is an authorized Registered Representative RR. Concurrently, there is displayed on the screen 13a of the authorized user a Welcome Page that enables the authorized user to further interact with the website 14 by pointing and clicking on interactive buttons IB appearing in the Welcome Page. These Welcome Pages are substantially the same for authorized Registered Representatives RR, authorized Broker/Dealers BD and their compliance officers CO, outside authors O/A, and other authorized user. For example, the “Representative Welcome Page” enables a Registered Representative RR to further interact with the website 14 by pointing and clicking on interactive buttons IB appearing in “Representative Welcome Page,” to search the electronic library, upload unapproved marketing materials for review and approval, and make any changes in his or her profile, that is, their identifying information such as address, Email, phone number, etc. These interactions are additional data, which are collected and stored in the memory SM to prepare the various reports.

As illustrated in FIG. 10B, the authorized user may search the library and, for example, enter through the “Representative Welcome Page” search criteria such as the works of a particular outside author O/A between a selected period such as the previous three (3) months. The search results are displayed on the screen 13a of the authorized user as a “Search Results” page that includes list of the items meeting the search criteria. As shown in FIG. 5, each individual item listed is an electronically interactive button IB, and by pointing and clicking on an individual item the authorized user selects the item for preview, and one of the following message pages appears on the user's screen 13a. In the case of an authorized Registered Representative RR, these messages are: Unreviewed, One Time Use, Preview Declined, Preview Allowed, or Premium (that is, payment required).

If the selected item to be downloaded is “Unreviewed,” the “Unreviewed” message page appears on the screen 13a and the authorized Registered Representative RR by pointing and clicking on an interactive button IB requests his or her compliance officer CO to approve access. A command is executed by the program 20 to store as data this request in the memory SM and identified, for example, as “Review Requests.” The program 20 may automatically send an Email to the compliance officer CO notifying him or her that such request is pending or alert the authorized Registered Representative RR to send such an Email to the compliance officer CO.

If the selected item to be downloaded is for “One Time Use,” the authorized Registered Representative RR in a similar manner by pointing and clicking on an appropriate interactive button IB executes the command for access. The “One Time Use” message page appearing on the screen 13a may require obtaining permission from the compliance officer CO to use this item. This “One Time Use” request is stored as data in the memory SM and identified, for example, as “One Time Use Records.” An Email may be sent automatically or the authorized Registered Representative RR may be alerted to send an Email to the compliance officer CO notifying him or her that such “One Time Use” request is pending. The “Preview Declined” message page appearing on the authorized Registered Representative's screen 13a, notifies him or her access to this item is declined, which may, for example, be an item that is to be distributed to only some authorized users.

When the “Preview Allowed” message page appears on the user's screen 13a, the authorized Registered Representative RR by pointing and clicking on an interactive button IB appearing on this message page may download to his or her computer system 12a a document D1 including the selected item of marketing material, for example, as a .pdf file that may be displayed on the screen 13a and stored in a memory of the user's computer system 12a. This download request and related information is stored as data in the memory SM and identified, for example, as “Message Usage Records.” Contemporaneously, the user by pointing and clicking on an interactive button appearing on this message page may download to his or her computer system 12a a document D2 comprising a compliance certificate, for example, as a .pdf file. When the “Premium” message appears on the user's screen 13a, the authorized Registered Representative RR by pointing and clicking on an interactive button IB appearing with this message page, will access a “Purchase Message Page.” The authorized Registered Representative RR by pointing and clicking on an interactive button IB appearing on the “Purchase Message Page,” may purchase the item using, for example, web pages similar to those used in purchasing access to the website 14. In other words, prior to the “Preview Allowed” message appearing on the user's screen 13a, a fee is paid to, for example, the outside author O/A of the “Premium” marketing materials being purchased.

As illustrated in FIG. 10C, an authorized user such as an authorized Registered Representative RR may upload unapproved marketing materials for review and approval by a compliance officer CO. The authorized Registered Representative RR by pointing and clicking on an interactive button IB appearing in the Welcome Page displayed on his or her screen 13a, commands through the program 20 a “Submit A Message Page” to be displayed on the screen 13a. As discussed above, this page enables the authorized Registered Representative RR to enter message information such as content, author, etc. and incorporate the message, for example, an item of unapproved marketing material UMM that is to be reviewed. This upload message information and unapproved marketing material UMM is stored as data in the memory SM and identified, for example, as “Message Library.” A “View Submitted Messages Page” may also be activated by pointing to and clicking an interactive button IB appearing on this page. An Email is sent automatically or, contemporaneously, the authorized Registered Representative RR may be alerted to send an Email to the compliance officer CO notifying him or her that an item of unapproved marketing material UMM is pending for their review and approval.

As depicted in FIG. 10D, an authorized user, for example, an authorized Registered Representative. RR, may change his or her profile by pointing and clicking on an interactive button IB appearing in Welcome Page displayed on his or her screen 13a. This causes a “Profile Edit Page” to be displayed on the user's screen 13a that enables the user to modify his or her information stored in the memory SM. This change request is stored as data in the memory SM and identified, for example, as “Review Requests.” An Email is sent automatically or, contemporaneously, the authorized Registered Representative RR may be alerted to send an Email to the compliance officer CO notifying him or her that new profile information is pending. A “View Confirmation Page” may also be activated by pointing to and clicking an interactive button IB appearing on this page.

FIGS. 10E through 10H depicts the way a compliance officer CO interacts with the website 14. As illustrated in FIG. 10E, a compliance officer CO upon connecting to his or her Welcome Page interacts with the website 14 and the various pending requests that need their review. The compliance officer CO by pointing and clicking on an interactive button IB appearing in the Welcome Page displayed on his or her screen 13a initiates a search through a command to the program 20. The Welcome Page has different interactive buttons IB to select the search criteria, for example, to review pending unapproved marketing materials UMM, or to approve a “One Time Use,” or to review the pending profile information changes. Depending on the type of criteria selected, an appropriate “Search Results” page is displayed on the compliance officer's screen 13a. For example, if unapproved marketing materials UMM are selected, a list of such materials is displayed on the screen 13a with each listed item being an interactive button IB. By pointing and clicking on one of these interactive buttons IB an item of unapproved marketing material UMM to be edited is displayed on the screen 13a as a “View Message” page, enabling the compliance officer CO to edit this material by pointing and clicking on an interactive button IB to display an “Edit Message” page. The compliance officer CO may now edit this material, and when finished points and clicks an interactive button IB on this page to display on the screen 13a the edited material on a “Confirm Changes” page. The compliance officer CO either again edits the material or approves the changes. When the compliance officer CO approves, he or she then commands the program 20 by pointing to and clicking an appropriate interactive button IB on the “Confirm Changes” page to store the data associated with this editing process in the memory SM and identified, for example, as “Message Library.” The program 30 also displays on the compliance officer's screen 13a a “View Message” page, and an appropriate interactive button IB on this page allows the compliance officer CO to add this newly approved item to the list of approved marketing material on the web page shown in FIG. 5. Automatically an Email is sent to the authorized Registered Representative RR requesting the approval or, contemporaneously, the compliance officer CO is alerted to send an Email to the authorized Registered Representative RR that his or her previously unapproved marketing material UMM has now been approved.

As illustrated in FIG. 10F, a compliance officer CO upon connecting to his or her Welcome Page may also interact with the website 14 to upload marketing materials MM that do not originated from an authorized Registered Representative RR, but that the compliance officer has approved. By pointing and clicking on an interactive button IB on the Welcome Page an “Add New Message Page” is displayed on the screen 13a of the compliance officer CO, enabling the compliance officer to enter the new material and the data associate therewith for storage in the memory SM and identified, for example, as “Message Library.” By pointing and clicking on an interactive button IB on the “Add New Message Page” the compliance officer CO may also display the “View Message” page and add this new material to the approved list of marketing materials shown in FIG. 5.

As depicted in FIG. 10G, a compliance officer CO upon connecting to his or her Welcome Page may also interact with the website 14 to review requests from authorized Registered Representative RR such as a One Time Use or Profile Change requests or interact with outside authors O/A or other authorized users. For example, by pointing and clicking on an appropriate interactive button IB on the Welcome Page a “Requests Page” is displayed on the screen 13a of the compliance officer CO. This “Requests Page” comprises a listing as interactive buttons IB identifying the numerous requests that the compliance officer CO must approve or decline. Pointing and clicking on one of these listed requests displays this one item on a “Request Page” that the compliance officer CO either approves or declines. Whether approved or declined, the data associated with this request is stored in the memory SM and identified, for example, as “Review Request,” and the user initiating the request is notified by Email as discussed above. If approved, the data associated with this approved request is stored in the memory SM and identified, for example, as “Requested Information.” As discussed above, the “View Confirmation Page” may also be used to enable the compliance officer CO, for example, to approve a One Time Use request or Profile Change request.

As illustrated in FIG. 10H, a compliance officer CO upon connecting to his or her Welcome Page may call up for display on his or her screen 13a and download any of the reports provided by my system 10. By pointing and clicking on an interactive button IB on the Welcome Page a “Reports Page” is displayed on the screen 13a of the compliance officer CO. The compliance officer CO points and clicks an interactive button IB on the “Reports Page” to command the program 20 to display a “Report Page” on his or her screen 13a. This “Report Page” has suitable interactive buttons IB to enable the compliance officer CO to enter criteria for creating the desired report. By pointing to and clicking interactive buttons IB on the “Report Page,” the compliance officer CO commands the program 20 to collect from the memory SM the data needed for the requested report, which may be displayed as a “View Report Results” page on his or her screen 13a and downloaded as one document D3 for Message files and Report document D4, for example, the report shown in FIG. 1B. The criteria as selected by the compliance officer CO may include dates, content of marketing material, identity of the authorized user, etc. The Message Files document D3 and a report document D4 may be downloaded as desired or imported to an Excel file or both. These documents D3 and D4 may be .pdf files or saved on compact disks or DVD's 21. These documents D3 and D4 may or may not include compliance certificates.

FIGS. 10I through 10K depicts the way an outside author O/A interacts with the website 14. As illustrated in FIG. 10E, an outside author O/A upon connecting to his or her Welcome Page by pointing to and clicking on an interactive button IB on this Welcome Page commands the program 20 to display on the screen 13a of the author's computer system 12a an “Add New Message Page.” Interactive buttons IB on this “Add New Message Page” enable the outside author O/A to enter information associated with new marketing material such as type of content and the material itself and submit this as data stored in the memory SM and identified, for example, as “Message Library.” A “View Message Page” may also be activated by pointing and clicking as discussed above and through this page, typically after approval by compliance officer CO, the new marketing material is stored in the library 16.

The outside author O/A may also approve or decline access to his or her marketing material. As illustrated in FIG. 10J, an outside author O/A upon connecting to his or her Welcome Page by pointing to and clicking on an interactive button IB on this Welcome Page display on the screen 13a of the author's computer system 12a a “Representative Requests Page” that lists as interactive buttons IB those requesting access to the outside author's marketing materials. Pointing and clicking on a listed request that functions as an interactive button IB commands the program 20 to display a “Requests Page” that has an interactive button or buttons IB enabling the outside author O/A to approve or decline a request for access. Whether such request for access is approved and declined, this data is stored in the memory SM and identified, for example, as “Reviewed Requests,” and an Email is sent as discussed above indicating that the request has been approved or declined. If approved, the data associated with this approved request is stored in the memory SM and identified, for example, as “Vendor/Representative Information.” A “View Confirmation Page” may also be activated by pointing and clicking as discussed above.

The outside author O/A may also obtain an activity report concerning those accessing his or her marketing materials. As illustrated in FIG. 10K, an outside author O/A upon connecting to his or her Welcome Page may by pointing to and clicking on an interactive button IB on this Welcome Page displayed on the screen 13a of the author's computer system 12a a “Reports Page.” The outside author O/A upon connecting to his or her Welcome Page may call up for display on his or her screen 13a and download the activity report. Different types of activity reports may be provided. The outside author O/A points and clicks on an interactive button to create the type of report desired and a “Report Page” is displayed on his or her screen 13a. This “Report Page” has suitable interactive buttons IB to enable the outside author O/A to enter criteria for creating the desired report and the report is displayed as a “View Report Results” page on his or her screen 13a. The criteria as selected by the outside author O/A may include dates, which one of several marketing material of the outside author O/A have been downloaded, the identity of the authorized user downloading the identified marketing material, etc. A Message Files document D5 and a report document D6 may be downloaded as desired in suitable formats as discussed above.

### Conclusion

My system and methods provides access online to literally thousands of marketing items (letters, flyers, invitations, notes and more) to authorized users or subscribers available 24 hours a day seven days a week. My system and methods is simple for authorized users or subscribers to add their own content. Additional content from top providers—such as, for example, Liberty Publishing, Response Mail Express and Bill Cates—is also in the library 16. Authorized brokers/dealers review the content, their authorized representatives download and use it . . . and the domain name owner provides authorized brokers/dealers with the ability to track the entire process.

My system and methods provide a simplified submission process. Most compliance offices CO receive marketing content review requests by mail, fax, e-mail . . . with no standardized process. My system and method upgraded that process—streamlining the process to allow authorized brokers/dealers B/D to receive, review and track marketing materials online with less hassle.

My system and method provides legacy reporting. NASD and SEC audits can require hundreds of man-hours. The extensive reporting features of my system and methods allow authorized brokers/dealers B/D to instantly create downloadable reports (Excel compatible) to track content, message usage and representative activity that are 17a-4 and SAS70 Audit II compliant.

The marketing material review process has several advantages, including but not limited to:
Review Once, Download Many (RODM Technology): Review documents once and allow for many representatives as selected to download for the amount of time an authorized Broker/Dealer B/D establishes.
Document Formats: My system supports several electronic document formats, including Word, Excel, Publisher, PowerPoint, and PDF documents.
Usage Regulation: An authorized Broker/Dealer B/D decides which representatives can access and utilize different types of marketing material.
Expiration Management: The authorized Broker/Dealer B/D can easily designate how long any item of marketing material is approved—one-time-usage, expiration by date, or unlimited usage (no expiration).
Internal File Numbers: The authorized Broker/Dealer B/D can attach and create internal file numbers to identify the Broker/Dealer's marketing material to simplify record keeping.
Compliance Certificates: The authorized Broker/Dealer B/D can download and print compliance certificates for an authorized Broker/Dealer's physical files.
NAB/D Review: The authorized Broker/Dealer B/D can easily include NAB/D review letters with documents.
Content Identification: The authorized Broker/Dealer B/D can identify and record the content of each item for future reporting.
Multiple Revision Management: The authorized Broker/Dealer B/D can easily track and review each revision.
Multiple Compliance Officers: My system allows many compliance officers to utilize the system with unique logins for tracking progress and activity.
Designate Compliance Relationships: The authorized Broker/Dealer B/D can assign selected compliance officers CO to specific authorized Registered Representatives RR to create ongoing relationships.
Specify Review Timeframes: The authorized Broker/Dealer B/D can create standard “turn-around times” for various communication types so authorized Registered Representatives RR know when to expect delivery.
Multiple Content Authors: The authorized Broker/Dealer B/D can access and manage content of any item from any marketing author anywhere.
Representative Management: The authorized Broker/Dealer B/D can easily review each authorized Registered Representatives RR order history, message history and activity.
E-mail Alerts: The authorized Broker/Dealer B/D can quickly create E-mail alerts to notify Officers when content is in need of review.

My system makes it fast and easy to organize, search and retrieve marketing messages at any time. Quickly review marketing messages, analyze usage, or evaluate activity. My system provides the following reports:
Usage Report: A list of all authorized brokers/dealers B/D and authorized Registered Representatives RR, and their marketing message usage.
Order History Report: List of all orders logged by an authorized brokers/dealers B/D and their authorized Registered Representatives RR.
Statistics Report: Review general statistics for an authorized brokers/dealers B/D and their authorized Registered Representatives RR.
   Message Reports including:
Activity Report: A detailed list of all marketing messages, including which Representatives have used them, and when.
Content Report: A catalogue of content types of marketing messages within the online library. Messages are displayed by category, including what percentage of the library each content type represents.
Usage Type Report: A complete list of usage types may be created by each individual Broker/Dealer, including marketing messages message statistics.

An electronic recordkeeping is employed in my system. Its progressive archiving provides a solution that meets the stringent recordkeeping requirements in compliance with the financial services industry standards, including, but not limited to, the following characteristics:
SEC Rule 240 (17a-3, 17a-4), SEC Rule 204-2 (Investment Advisors Act of 1940)
NASD Rule 3010, NASD Rule 3110, NASD Notice to Members 98-11, NASD Notice to Members 03-33
Employs electronic storage media on WORM Media that can provide representation that the storage medium is meeting specified conditions of rule 17a-4.
Electronic records stored in non-rewriteable, non-erasable format.
All back-ups are stored separately from their originals.
All electronic records arranged to permit the immediate retrieval of any record that may be requested.
Printed version of messages and logs may be printed by Broker/Dealer or provided at the website 14, for example, www.MarketingLibrary.net.
Business Continuity Plan: Printed procedures for maintenance and preservation of, and access to, records—so as to reasonably safeguard records from loss, alteration, or destruction.
Retention Period Each authorized brokers/dealers B/D may determine the period of their record retention. All records (logs and messages) may be retained for 1 year, 3 years, 5 years, 6 years or indefinitely.

### Scope of the Invention

The above presents a description of the best mode of my website, system and methods, and of the manner and process of making and using them, in such full, clear, concise, and exact terms as to enable any person skilled in the art to which they pertain to make and use my website, system and methods. My website, system and methods are, however, susceptible to modifications and alternate constructions from the illustrative embodiment discussed above which are fully equivalent. Consequently, it is not the intention to limit my website, system and methods to the particular embodiment disclosed. On the contrary, my intention is to cover all modifications and alternate constructions coming within the spirit and scope of my website, system and methods as generally expressed by the following claims, which particularly point out and distinctly claim the subject matter of my website, system and methods:

### Marketing Library Broker/Dealer Agreement

This Marketing Library Broker/Dealer Agreement (“Agreement”) is made and entered into as of this day of 2007 (the “Effective Date”), by and between MarketingLibrary.net, Inc. (“ML.net”) and (referred to hereinafter as “you” or “Broker/Dealer”).

### Recitals

WHEREAS, ML.net. owns and maintains the MarketingLibrary.net website (the “Site”) as well as the Marketing Library internet-based software application (the “Application”).

WHEREAS, you desire to have access to the Site and Application to manage the Messages available for use by your Registered Representatives and to permit your Registered Representatives who have purchased an individual subscription to the Site and Application to obtain Messages pre-approved by you.

NOW THEREFORE, in consideration of the premises and mutual covenants hereinafter contained, you and ML.net (the “Parties”) hereby mutually agree as follows:

### Definitions

The following definitions shall apply to the specified terms throughout this Agreement as well as within the Site and Application:

“Message”—this term shall mean and refer to any and all marketing and business management materials for financial products and/or services obtained through the Site and Application, whether originally submitted by a Registered Representative for review and editing, obtained from the Site and Application's existing library of materials, provided by you or another broker/dealer through the Site and Application, or provided by a Third Party Provider through the Site and Application. Said marketing materials include, but are not limited to, postcards, e-mails, letter, flyers, invitations, presentations, brochures, contracts, facsimiles, newsletters, articles, seminars, surveys, website content, stationary, and prospectuses.
“Approved”—this term shall mean and refer to Messages that have been reviewed and approved by you for use by your designated Registered Representatives who have purchased an individual subscription and are properly authorized to use the Site and Application. A Message's designation as “Approved” does not relieve you or the individual Registered Representative from any liability arising from the content or representations of such Message. ML.net. shall not be liable for such content or representations and ML.net. does not agree to indemnify you or any individual Registered Representatives against liability arising from any Registered Representative's use of a Message designated as “Approved.”
“Approved With Changes”—this term shall apply only to those Messages submitted by an individual Registered Representative to ML.net. and/or you for review and editing through the Site and Application. This term shall mean and refer to Messages approved for publication as long as certain changes specified by the compliance officer are incorporated. A Message's designation as “Approved With Changes” does not relieve you or the individual Registered Representative from any liability arising from the content or representations of such Message. ML.net. shall not be liable for such content or representations and ML.net. does not agrees to indemnify you or any individual Registered Representatives against liability arising from any Registered Representative's use of a Message designated as “Approved With Changes.”
“Broker/Dealer Library”—this term shall mean and refer to those areas of the Site reserved for access by you and your Registered Representatives who have purchased an individual subscription and are properly authorized to use the Site and Application.
“Declined”—this term shall mean and refer to Messages that have been rejected by ML.net. or you and may not be published by your Registered Representatives. The Broker/Dealer and its Registered Representatives shall be solely responsible for any liability arising from their use of any Message designated as “Declined.”
“Exclusive Option”—this term shall be used exclusively in connection with Messages submitted by individual Registered Representatives to ML.net. for compliance review and editing. All Messages submitted to ML.net. for review and editing shall remain exclusive for Registered Representative's sole use. Accordingly, other users of the Site and Application, including your other Registered Representatives will not be provided access to those Messages submitted by other Representatives.
“Not Approved”—this term shall mean and refer to Messages that have not been reviewed by you for use by your Registered Representatives and may not be published by your Registered Representatives. Broker/Dealers and their Registered Representatives shall be solely responsible for any liability arising from their use of any Message designated as “Not Approved.”
“Registered Representatives”—this term shall mean and refer to any sales representatives affiliated with Broker/Dealer who has been individually authorized to access and use the Site and Application through the purchase of an individual user subscription for the Site and Application and has entered into the standard “Marketing Library User Agreement.”
“Third Party Provider”—this term shall mean and refer to any provider of Messages that is not you, ML.net. or an individual Registered Representative. Such Third Party Providers may include financial product sponsors or independent marketing material content providers.
“Withdrawn”—this term shall mean and refer to Messages submitted by individual Registered Representatives to ML.net. and/or you for review and editing through the Site and Application where such review and editing is cancelled at the Registered Representative's request. Broker/dealers and their Registered Representatives shall be solely responsible for any liability arising from their use of any Message designated as “Withdrawn.”
Additional definitions for terms used within the Site and Application may, from time to time, be provided by ML.net. in its sole and absolute discretion and posted on the Site.

### Agreement

1. THE SITE AND APPLICATION. By entering into this Agreement and the terms of use contained herein, the Site and Application will provide you, the Broker/Dealer, with a forum through which your authorized representatives may obtain marketing materials, pre-approved by you. Said forum will be the Broker/Dealer Library. ML.net. shall not be responsible for any specific representations made in the marketing materials themselves or any additional content inserted into the materials after ML.net. has provided them to you or your representatives. Only those Messages to which you have consented will be available to your individual Registered Representatives via the Broker/Dealer Library. Furthermore, at your discretion you may control which Registered Representatives have access to certain Messages via the Broker/Dealer Library by properly categorizing your Registered Representatives in the categories which you may devise. You shall bear all responsibility and liability associated with the proper categorization of your Registered Representatives and with the approval of specific Messages to be made available to Registered Representatives in a given category. In the event any claim, action or liability is asserted against ML.net as a result of your negligence or misuse of either the Site or the Application, including but not limited to any improper modification of any Site content, then you will defend, indemnify and hold ML.net harmless pursuant to terms set forth in section 22 herein.
2. RESTRICTIONS ON USE. The entire Site and Application, including but not limited to all pages within the website and any material made available for download, including but not limited to all Messages not submitted under the Exclusive Option, are the property of ML.net., its affiliates, and/or a Third Party Provider. The Site and Application and all aspects thereof are protected by federal and international copyright and trademark laws. Any rights not expressly granted by these Terms and Conditions or any applicable end user license agreements are reserved by ML.net.
3. USER SUBSCRIPTIONS. The Site and Application are available for use by individual representatives only through the purchase of a User Subscription. A true and correct copy of the standard “Marketing Library User Agreement” is attached hereto as Exhibit “A” and incorporated herein. You hereby consent to your individual representatives entering into said agreement. Furthermore, you acknowledge that, pursuant to the “Marketing Library User Agreement,” each individual representative's license to use the Site and Application is non-transferable. Accordingly, individual representatives are assigned a personal account, user name, and password which are to remain confidential and are not to be used by other individuals, including but not limited to other representatives affiliated with you or your other employees or agents. You agree that you shall not attempt to interfere with the confidentiality and non-transferability obligations enumerated in the “Marketing Library User Agreement.”
4. BROKER/DEALER ACCESS AND USE. A. Term. You may access and use the Site and Application pursuant to this Agreement as of the Effective Date, which may precede the date on which you begin using the Site or Application. The initial term of your authorized access to and use of the Site and Application (the “Initial Term”) shall be one (I) year in length.

B. Automatic Renewal. Upon completion of the Initial Term, your right to access and use the Site and Application will renew automatically on a month-to-month basis (each, a “Renewal Month”) unless you provide ML.net. with notice of termination at least thirty (30) days prior to the end of the Initial Term. Any such notice must be provided to ML.net. by speaking with a ML.net. customer service representative at 888-730-5300 (or such other number as specified by ML.net. from time to time), e-mailing support@marketinglibrary.net or completing the cancellation steps inherent in the system. If you provide ML.net. with the appropriate termination notice prior to the end of the Initial Term, your Subscription shall continue only until the end of the Initial Term, and you shall be liable only for those fees, taxes, and other charges incurred in connection with your Subscription (collectively, “Subscription Fees”) that accrue prior to such date. After the Initial Term, you may terminate your Subscription as of the end of any Renewal Month by speaking with a ML.net. customer service representative at 888-730-5300

C. Billing Information. For purposes of billing, identification, and future communications, you must provide ML.net. with all information requested by ML.net. at the time you submit your Subscription order. Without limitation, you must provide your full legal name (i.e., the name of the Broker/Dealer), the full legal name of the individual entering into this Agreement on behalf of the Broker/Dealer, said individual's position with Broker/Dealer, address, telephone number(s), email address, and applicable payment data (e.g., a credit card number and expiration date) (“Registered Representative Data”). You agree to provide true, accurate and complete information and to refrain from impersonating or falsely representing your affiliation with any person or entity. Registered Representative Data and certain other information about you and/or your business are subject to our Privacy Policy. You agree and acknowledge that Registered Representative Data from the registration process is used to send you information about the Site and Application, including, but not limited to, the use of your email address for newsletters and other necessary communications. You further agree that, in the event that any Registered Representative Data changes during the course of your Subscription, you must provide updated Registered Representative Data as soon as possible. See ML.net.'s Privacy Statement at http://www.MarketingLibrary.net/privacy.asp for disclosures relating to ML.net.'s collection and use of your personal information.

D. Service Fees. The Service Fee for your authorized access and use of the Site and Application during the Initial Term, which shall be payable to ML.net. upon execution of this Agreement, shall be an initiation fee (See Exhibit A) and a monthly subscription fee of $10 per month, per Registered Representative. ML.net. may establish or change Service Fees for Renewal Months by posting such fees on either of the websites located at www.MarketingLibrary.net (or on a sub-page of either of those websites), by posting a conspicuous notice in the Site or Application, by emailing you, or by otherwise notifying you either orally or in writing in advance of the applicable Renewal Month. All Service Fees will be billed to the credit card that you designate during registration (or such other credit card as you may designate from time to time) or billed directly to the Credit Cards of your Registered Representatives, as the case may be. All monthly, annual, or other periodic Service Fees will be billed automatically to the credit card supplied at the start of each such period during the Initial Term. For Renewal Months, the monthly Service Fees will be billed to the supplied credit card each month on the date that corresponds with the date of this Agreement during the relevant month. All Service Fees are nonrefundable. At ML.net.'s discretion, past due Service Fees are subject to interest at the rate of 1.5% per month, or the maximum permitted by law, whichever is less. You shall be responsible for all expenses (including, without limitation, reasonable attorneys' fees) incurred by ML.net. in connection with the collection of any past due Service Fees.

5. USER NAMES AND PASSWORDS. You will be required to choose (or, at ML.net.'s discretion, you will be assigned) a user name and password for the Site and Application. Your user name and password are for your exclusive use and may not be shared with your Registered Representatives any of your employees or agents who are not responsible for managing your use and access to the Site and Application. You are solely responsible for maintaining the confidentiality of your user name and password, and for all activities that occur under your user name and password. You must notify ML.net. immediately if you become aware of any unauthorized use of your user name or password, or if you become aware of any other breach of security regarding the Site or Application. ML.net. will not be liable for any loss or damage that you may incur as a result of someone else using your user name or password, either with or without your knowledge.
6. INTERNET ACCESS; SYSTEM REQUIREMENTS. Use of the Site and Application, or certain parts thereof, requires access to the Internet. Additionally, use of the Site and Application may require particular equipment, software, and/or telecommunications services, and ML.net. may change those requirements from time to time in its sole discretion and without prior notice. You are solely responsible for obtaining, configuring, maintaining, and paying for all equipment, software, and telecommunications services necessary for you to access the Internet and use the Site and Application.
7. BROKER/DEALER LICENSE. A. Administrator License Grant. During the term of this Agreement, and subject to all other terms and conditions herein, ML.net. hereby grants you a personal, limited, revocable, nonexclusive, non-sublicensable, nontransferable administrator license to do the following, but only for your own internal business purposes and only in a manner consistent with all applicable end user documentation: (a) access Messages in order to approve such Messages for use by your representatives and (b) to access the Broker/Dealer Library.

B. Limitations. Except as expressly permitted above in this Section 7, you may not use or reproduce the Application or the Site, including but not limited to any of the materials and Messages available via the Site and/or Application. To the maximum extent permitted by applicable law, you may not: (a) sell, sublicense, rent, lend, lease, timeshare, commercialize, or transfer the Site or Application, or otherwise make the Site or Application available, to any third party; (b) use the Site or Application for the benefit of any third party; (c) modify, translate, or create derivative works of the Site or Application; (d) reverse assemble, reverse compile, or reverse engineer the Site or Application; (e) alter or modify any disabling mechanism that may be resident in the Site or Application; (f) remove, alter, or obscure any copyright notice or other proprietary notice or legend that is on or in the Site or Application; (g) access or use the Site or Application for fraudulent purposes, in violation of any applicable laws, or in violation of this Agreement (as it may be modified from time to time). If a license to use the Site or Application was purchased in the United States, you agree to comply with all applicable United States laws and regulations pertaining to export controls. If a license to use the Site or Application was purchased outside the United States, you may not re-export the Site or Application except as permitted by the laws of the United States and the laws of the jurisdiction in which you purchased a license to use the Site or Application. Any reproduction, modification or redistribution of the Site or Application is expressly prohibited, and may result in severe civil and criminal penalties. The Site and Application, their structure, sequence and organization and source code are considered trade secrets of ML.net. and are protected by trade secret laws. WITHOUT LIMITED THE FOREGOING, COPYING OR REPRODUCING THE SITE OR APPLICATION TO ANY OTHER SERVER OR LOCATION FOR FURTHER REPRODUCTION OR REDISTRIBUTION IS EXPRESSLY PROHIBITED. YOU MAY NOT DECOMPILE OR DISASSEMBLE, REVERSE ENGINEER OR OTHERWISE ATTEMPT TO DISCOVER ANY SOURCE CODE CONTAINED IN ANY SOFTWARE PROVIDED HEREUNDER.

8. OWNERSHIP OF THE SITE, APPLICATION, AND MESSAGES. Except for the limited license granted in Section 7 above, ML.net. and its licensors own and retain all right, title, and interest in and to the Site and Application, all copies of the Application, all data, compilations, and information underlying or relating to the Site and Application (other than any Content, as defined below), and all intellectual, industrial, and proprietary rights in or relating to any of the foregoing (including, without limitation, all copyrights, patents, trademarks, and trade secrets). Furthermore, ML.net. or Third Party Vendors, as the case may be, retain all right, title, and interest in all Messages, except those Messages submitted by individual Registered Representatives under the Exclusive Option.

A. Site History Retention. Broker/Dealer may designate how long their Registered Representative's “Site History” (defined as the records of each Registered Representative's downloading or uploading of Messages from or to the Site) shall be maintained by ML.net. Site History and Messages will be automatically archived on a daily basis to firm specific folders on both a primary and back-up servers and shall be maintained for a minimum of one (1) year, measured from the date of a given downloading or uploading event. However, Broker/Dealer may request a lengthier retention period as follows: Check your preferred Site History Retention period (Check One)—1 Year; 1 Year plus ______ Months; Indefinitely. Broker/Dealer may request to receive a copy of the Site History and Messages on WORM optical disk media for the additional cost of $250 per disk.(i.e., “write once, read many”, a data storage technology that allows information to be written to a disc a single time and prevents the drive from erasing the data). ML.net. shall have no further obligation to retain Site History after termination of this Agreement. Accordingly, if Broker/Dealers desires to receive a back-up of the Site History occurring prior to such termination, a back-up must be requested pursuant to this section concurrently with the termination of this Agreement.

9. BROKER/DEALER CONTENT. A. Representations. You are solely responsible for any and all data, diagrams, pictures, text, information, and other materials that you input, store, or transmit using the Application (collectively, your “Content”). You hereby represent and warrant to ML.net. that your Content will not: (a) infringe upon or otherwise violate any intellectual or industrial property rights (including, without limitation, copyrights, patent rights, trademark rights, and trade secret rights), or any other rights (such as the rights of privacy and publicity), of any third party; (b) contain any software viruses or other computer code, files, or programs designed to interrupt, destroy, or limit the functionality of any equipment, software, or telecommunications services; (c) contain any unlawful, harassing, harmful, threatening, profane, defamatory, or obscene materials; or (d) violate any applicable laws.

B. Storage. You may store your Content on ML.net.'s servers for use with the Site and Application, and ML.net. will use commercially reasonable efforts to backup such Content at least one time per week. However, you acknowledge and agree that ML.net. has no responsibility or liability for any deletion, destruction, corruption, or other loss of such Content. ML.net. may, from time to time, set limits on the amount of disk space allotted to you for the storage of your Content on ML.net.'s servers. Further, ML.net. may charge storage fees for exceeding those limits. You will be notified of any such limits and storage fees (or any changes thereto) through email, through a notice posted in a conspicuous place in the Application, through a notice posted on either of the websites located at www.MarketingLibrary.net (or on a sub-page of this website), or through some other form of notice provided either orally or in writing.

10. TECHNICAL SUPPORT. ML.net. will, to the extent commercially reasonable, attempt to assist you with accessing and using the Site and Application (“Technical Support”). ML.net. will, at your option, provide you with Technical Support via telephone, facsimile, and/or email. Technical Support staff is available between the hours of 9:00 AM and 5:00 PM, Pacific Standard Time, Monday through Friday. However, Technical Support response times may vary depending upon the nature of the support requested and the quantity of other support requests. ML.net. may modify its Technical Support policies and procedures (including, without limitation, availability dates and times and communication methods) from time to time in its sole discretion and without notice. For further information regarding Technical Support, please visit ML.net.'s website at www.MarketingLibrary.net.

11. MAINTENANCE. ML.net. will use commercially reasonable efforts to promptly repair faults in the Site and Application that materially degrade its functionality or performance, or that cause it to be inaccessible to subscribers. ML.net. may also perform other maintenance on the Site and Application from time to time in its sole discretion. You shall not be entitled to any abatement in Service Fees for any Site and Application faults or downtime.
12. MODIFICATIONS. ML.net. may upgrade, enhance, change, suspend, discontinue, or otherwise modify any aspects or components of the Site and Application (collectively, “Modifications”) at any time in its sole and absolute discretion and without notice. Any Modifications made available to you will be subject to the terms of this Agreement. You shall not be entitled to any abatement in Service Fees for any Modifications.
13. SUSPENSION; TERMINATION. If ML.net. believes, in its sole discretion, that you have violated any term or condition in this Agreement, ML.net. may suspend your access to and use of the Site and Application until such time as ML.net. believes, in its sole discretion, that you have cured such violation or that such violation did not occur. Any such suspension shall not entitle you to any abatement in Service Fees. If you breach or otherwise fail to comply with any of the terms or conditions in this Agreement, ML.net. may terminate your access to and use of the Site and Application immediately and without notice, and you shall not be entitled to a refund of any pre-paid Service Fees. ML.net. may also terminate your access to and use of the Site and Application for any reason or no reason whatsoever upon thirty (30) days prior notice via email or otherwise in writing, in which event you shall receive a prorated refund of any prepaid, periodic Service Fees (such proration to be calculated using the date on which the Agreement terminated). You may terminate your access to and use of the Site and Application by written notice to ML.net. if ML.net. materially breaches this Agreement and fails to cure such breach within thirty (30) days following receipt of written notice from you describing the breach in reasonable detail. If you terminate your access to and use of the Site and Application due to a material breach by ML.net., you shall be entitled to a prorated refund of any prepaid, periodic Service Fees (such proration to be calculated using the date on which the Agreement terminated). Upon any expiration or termination of your access to and use of the Site and Application, (a) this Agreement shall automatically and immediately terminate, (b) you will no longer be allowed to access and use the Site and Application, (c) you must remove all copies of the Application, or any components thereof, from your personal computer(s) and destroy any and all related media and documentation, (d) you shall remain liable for all Service Fees that have accrued but remain unpaid as of the date of such expiration or termination, and (e) Sections 2, 5, 8, 9, 13, 18, 19, 20, 21, 23, 24, and 27 of this Agreement shall survive and shall remain in full force and effect in perpetuity. Ninety (90) days following any expiration or termination of your access to and use of the Site and Application, ML.net. may delete any or all of your Content that is stored on any ML.net. servers. YOU ACKNOWLEDGE AND AGREE THAT THE SITE AND APPLICATION MAY HAVE A MECHANISM WHEREBY ML.net. CAN LIMIT OR DISABLE YOUR ACCESS TO THE SITE AND APPLICATION. YOU AGREE THAT ML.net. MAY USE SUCH MECHANISM UPON ANY EXPIRATION OR TERMINATION OF YOUR ACCESS TO AND USE OF THE SITE AND APPLICATION, OR IF ML.net. SUSPENDS YOUR ACCESS TO OR USE OF THE SITE AND APPLICATION AS PERMITTED IN THIS SECTION 13. IF MARKETINGLIBRARY.NET TERMINATES A BROKER/DEALER RELATIONSHIP, FOR ANY REASON, THAT BROKER/DEALER WILL RECEIVE WORM MEDIA WITH THEIR REPRESENTATIVE HISTORY AND CORRESPONDING FILES AT NO COST.
14. ADVERTISING ON THE SITE GENERALLY. ML.net. may, in its sole and absolute discretion, place its own advertising as well as advertising of third parties on any portion of the Site. Such advertising may include, without limitation, pop-ups, landing pages, banners, and crawlers.
15. ADVERTISING ON BROKER/DEALER LIBRARY. Advertisements for ML.net. or any of its parents or subsidiaries may be placed on the Broker/Dealer Library in the sole and absolute discretion of ML.net. Broker/Dealer recruiting advertisement is strictly prohibited. All other advertisers with advertising appearing on the Broker/Dealer Library shall be subject to your approval, including but not limited to advertisements by registered investment advisors, insurance companies or brokers, annuity third party marketers, mutual funds, variable annuities, index annuities, and practice management companies. However, determinations regarding the form (e.g., pop-ups, landing pages, banners, and crawlers), size, and scope of advertising appearing in the Broker/Dealer Library shall be in ML.net's sole and absolute discretion.
16. ADVERTISING REVENUE SHARING. You shall be entitled to share in revenues realized for advertising appearing in the Broker/Dealer Library as follows:

A. Where ML.net., including any of its employees or agents, is the procuring cause for such advertising, advertising revenues shall be shared seventy-five percent (75%) to ML.net. and twenty-five percent (25%) to you.

B. Where you, including any of your employees or agents, are the procuring cause for such advertising, advertising revenues shall be shared fifty percent (50%) to you and fifty percent (50%) to ML.net.

You shall be entitled to receive payments pursuant to the advertising revenue sharing plan enumerated above within forty-five (45) days of the applicable advertiser's full payment of amounts due for such advertising. You shall not be entitled to receive any revenue sharing compensation for any advertisements for ML.net. or its parents or subsidiaries which appear in the Broker/Dealer Library. You shall not be entitled to receive any revenue sharing for advertising for which no payment or only partial payment is received by ML.net. Amounts due to you pursuant to this Section 16 shall be offset against any Service Fees outstanding at the time of accrual. ML.net. shall retain sole and absolute discretion with respect to determinations regarding pricing of all advertising and reserves the right to modify or alter any advertising fee schedules at any time.
17. THIRD PARTY CONTENT. The Site contains content and information from Third Party Providers and/or links to third party Web sites, including but not limited to advertising (“Third Party Content”). Such content is not under the control of ML.net. and ML.net. is not responsible for such content, including, without limitation, any link contained in such content, or any changes or updates to such content. ML.net. is providing such Third Party Content to you only as a convenience, and the inclusion of such content does not imply endorsement by ML.net. of such content or the affiliate. You may be subject to additional and/or different terms, conditions, and privacy policies when you use third party services, content, software, or sites. ML.net. does reserve the right to remove content that, in ML.net.'s judgment, does not meet its standards, but ML.net. is not responsible for any failure or delay in removing such material. ML.net. is not and will not be responsible for (i) the terms and conditions of any transaction between you and any third party, (ii) any insufficiency of or problems with any such third party's background, insurance, credit or licensing, or (iii) the quality of services performed by any such third party or any other legal liability arising out of or related to the performance of such services. In the event that you have a dispute with any such third party, you release ML.net. (and its affiliates, suppliers, agents and employees) from any and all claims, demands and damages (actual and consequential) of every kind and nature, known and unknown, suspected and unsuspected, disclosed and undisclosed, arising out of or in any way connected with such disputes. Messages generated by Third Party Providers may be made available through the Site and Application subject to this Section. Such Message are the property of the corresponding Third Party Provider. Accordingly, your use or your Registered Representative's use of such Messages may be subject to additional or different licenses than those specified herein and may be subject to additional fees not included in the Service Fees specified in Section 4 herein.
18. COMPLIANCE WITH SEC RULE 17a-4. Compliance with SEC Rule 17a-4 and all other rules and regulations, is a responsibility of the Broker-Dealer that cannot be assigned to ML.net. or any other third party. ML.net. will store the information related to the use of Broker/Dealer Library by you and your Representatives in a manner consistent with the requirements of Rule 17a-4 of the Securities Exchange Act of 1934. ML.net. is prepared to sign an undertaking consistent with Rule 17a-4(f)(3)(vii). The undertaking will have the form:
The undersigned hereby undertakes to furnish promptly to the U.S. Securities and Exchange Commission (“Commission”), its designees or representatives, upon reasonable request, such information as is deemed necessary by the Commission's or designee's staff to download information kept on the broker's or dealer's electronic storage media to any medium acceptable under Rule 17a-4.
Furthermore, the undersigned hereby undertakes to take reasonable steps to provide access to information contained on the broker's or dealer's electronic storage media, including, as appropriate, arrangements for the downloading of any record required to be maintained and preserved by the broker or dealer pursuant to Rules 17a-3 and 17a-4 under the Securities Exchange Act of 1934 in a format acceptable to the Commission's staff or its designee. Such arrangements will provide specifically that in the event of a failure on the part of a broker or dealer to download the record into a readable format and after reasonable notice to the broker or dealer, upon being provided with the appropriate electronic storage medium, the undersigned will undertake to do so, as the Commission's staff or its designee may request.
   19. PROTECTION OF INFORMATION. ML.net. will take reasonable steps to ensure the security and confidentiality of any information contained in the Broker/Dealer Library. In the event that ML.net is notified of or otherwise detects a breach of security it will immediately notify you.
   20. NO REPRESENTATIONS OR WARRANTIES. The Site and Application are provided on an “as available,” “as is” basis. To the maximum extent permitted by applicable law, ML.net. and its parent companies, subsidiaries, affiliates, suppliers, and licensors disclaim all representations and warranties of any kind with respect to the Site, Application, and any Messages, including but not limited to implied warranties of non-infringement, title, merchantability, quiet enjoyment, quality of information, and fitness for a particular purpose. Without limiting the generality of the foregoing: ML.net. does not represent or warrant that the Site, the Application, or the Messages will meet your requirements, that the operation of the Site or Application will be uninterrupted or error-free, or that defects in the Site, the Application, the Messages or related documentation will be corrected. ML.net. makes no representation or warranty of any kind, express or implied, as to the speed, operation, or reliability of the Site or Application, the accuracy or completeness of any information accessible via the Site or Application, or the availability, quality, or safety of Messages or any other products or services available through the Site or Application. Further, ML.net. does not represent or warrant that the Site or Application, or the content available through the Site or Application, are free of viruses or other harmful components. No oral or written information or advice given to you or your agent by ML.net. or any other party with respect to the Site or Application or anything related thereto shall create a representation or warranty, or in any way increase the scope of ML.net.'s obligations hereunder. ML.net. assumes no responsibility and makes no representations, warranties, recommendations, endorsements, or approvals with regard to any Messages, opinions, advice, statements, products, services, offers, or other information or materials expressed or made available by third parties, including but not limited to Third Party Providers, through or in connection with the Site or Application. You assume total responsibility and risk for your use of the Site, the Application, and any and all Messages and related services.
   21. LIMITATIONS ON LIABILITY. TO THE MAXIMUM EXTENT PERMITTED BY APPLICABLE LAW, IN NO EVENT SHALL ML.NET. OR ITS PARENT COMPANY, SUBSIDIARIES, AFFILIATES, SUPPLIERS, OR LICENSORS BE LIABLE FOR ANY DAMAGES WHATSOEVER, WHETHER DIRECT, INDIRECT, PUNITIVE, EXEMPLARY, SPECIAL, INCIDENTAL, CONSEQUENTIAL, OR OTHER DAMAGES (INCLUDING, WITHOUT LIMITATION, DAMAGES FOR PERSONAL INJURY, LOST PROFITS, LOST DATA, AND/OR BUSINESS INTERRUPTION), ARISING OUT OF OR RELATING IN ANY WAY TO THE USE OR INABILITY TO USE THE SITE OR APPLICATION, AN RELATED SERVICES, OR ANY CONTENT OR INFORMATION CONTAINED THEREIN EVEN IF ML.NET. OR ANY SUCH RELATED PARTY HAS BEEN ADVISED OF THE POSSIBILITY OF SUCH DAMAGES. IN ANY CASE, ML.NET.'S ENTIRE LIABILITY UNDER THIS AGREEMENT SHALL BE LIMITED TO THE AGGREGATE SERVICE FEES PAID BY YOU DURING THE IMMEDIATELY PRECEDING TWELVE (12) MONTH PERIOD. YOU AGREE THAT YOU WILL HAVE SOLE AND COMPLETE RESPONSIBILITY FOR ANY DECISIONS MADE OR ACTIONS TAKEN BY YOU IN RELIANCE UPON THE SITE OR APPLICATION. YOU ACKNOWLEDGE AND AGREE THAT THE SITE AND APPLICATION ARE NOT INTENDED TO SUPPLY TAX, INVESTMENT, OR LEGAL ADVICE. IT IS EXPRESSLY UNDERSTOOD AND AGREED THAT IN THE EVENT ANY REMEDY HEREUNDER IS DETERMINED TO HAVE FAILED OF ITS ESSENTIAL PURPOSE, ALL LIMITATIONS OF LIABILITY AND EXCLUSIONS OF DAMAGES SET FORTH HEREIN SHALL REMAIN IN EFFECT.
   22. INDEMNIFICATION. You agree to indemnify, defend, and hold harmless ML.net., its employees, members, directors, managers, officers or agents from and against any loss, liability, damage, penalty or expense (including attorneys' fees, expert witness fees and cost of defense) they may suffer or incur as a result of (i) any failure by you or any representative, employee or agent of you to comply with the terms of this Agreement; (ii) any warranty or representation made by you or your representative being false or misleading; (iii) any representation or warranty made by you or your representative or any employee or agent of you to any third person other than as specifically authorized by this Agreement, (iv) negligence of you or your representatives, subcontractors, agents or employees, and/or (v) any alleged or actual violations by you or your representatives, subcontractors, employees or agents of any governmental laws, regulations or rules.
   23. U.S. GOVERNMENT RESTRICTED RIGHTS. The Site and Application and any related documentation are provided with RESTRICTED RIGHTS. Use, duplication, or disclosure by the United States Government is subject to restrictions as set forth in subparagraph (c)(1)(ii) of the Rights in Technical Data and Computer Software clause at DFARS 252.227-7013 or subparagraphs (a) through (d) of the Commercial Computer Software—Restricted Rights at 48 CFR 52.227-19, and in similar clauses in the NASA FAR Supplement, as applicable. Manufacturer is ML.net., 150 El Camino Real, Ste. 200, Tustin, Calif. 92780, USA.
   24. ARBITRATION. Any and all disputes, controversies, or claims arising out of or relating to this Agreement, including without limitation, claims based on contract, tort, or statute, shall be determined by binding arbitration by the American Arbitration Association. The parties shall have the right to conduct discovery pursuant to the California Code of Civil Procedure. The arbitration shall be venued in Orange County, Calif. This Agreement to arbitrate is intended to be binding on and to inure to the benefit of the parties to this Agreement, their principals, successors, assigns, affiliates, partners, employees, parent or subsidiary entities, and to any other parties whose claims or defenses may arise out of or relate to this agreement. The prevailing party shall be entitled to recover its reasonable attorney fees, expert fees, and costs. Judgment on the award rendered by the arbitrator may be entered in any court having jurisdiction.
   25. MODIFICATIONS TO TERMS OF USE. ML.net. may modify the terms of Broker/Dealer's or individual Registered Representatives' use of the Site and Application from time to time in its sole discretion. ML.net. will notify you of any such modifications by email, by posting a conspicuous notice in the Site and Application, or otherwise in writing (each, a “Modification Notice”). You must contact ML.net. immediately following your receipt of a Modification Notice if you do not agree to such modifications. By continuing to use the Site and Application or any aspect or component thereof after ML.net. sends or posts (as applicable) a Modification Notice, you are agreeing to such modifications.
   26. MISCELLANEOUS. This Agreement constitutes the entire understanding and agreement between ML.net. and you with respect to the subject matter hereof, and supersedes all prior or contemporaneous oral or written communications with respect to the subject matter hereof, all of which are merged herein. This Agreement is governed by and construed in accordance with the laws of the State of California, U.S.A, as applied to agreements entered into and wholly performed within California between California residents. In any action arising from this Agreement, the prevailing party shall be entitled to recover its costs, including expert witness fees, and attorney's fees from the other party. THIS AGREEMENT SHALL NOT BE GOVERNED BY THE 1980 U.N. CONVENTION ON CONTRACTS FOR THE INTERNATIONAL SALE OF GOODS. In the event that any provision of this Agreement is found invalid or unenforceable pursuant to judicial decree, the remainder of this Agreement shall remain valid and enforceable according to its terms. Any failure by ML.net. to strictly enforce any provision of this Agreement will not operate as a waiver of that provision or any subsequent breach of that provision. ML.net. shall not be responsible for any delays, errors, failures to perform, interruptions, or disruptions in the Site and Application caused by any acts of God, strikes, lockouts, riots, acts of war, changes in law or regulations, fire, flood, earthquake, storm, power failure, or failures of the Internet. Any notices from ML.net. under this Agreement that are sent by email, or that are posted in the Application or on ML.net.'s website at www.MarketingLibrary.net (or on a sub-page thereof), shall be deemed given when sent or posted, as applicable. As a condition of your use of the Site and Application, you warrant to ML.net. that you will not use the Site for any purpose that is unlawful or prohibited by this Agreement or by applicable laws or regulations. The individual entering into this Agreement on behalf of Broker/Dealer herein, hereby personally represents and warrants that he/she has the requisite authority to enter into this Agreement on behalf of such Broker/Dealer.

IN WITNESS WHEREOF, the Parties have caused their respective authorized representatives to execute this Agreement as of the day and year first above written. MarketingLibrary.net, Inc. “BROKER/DEALER”

### By By: ______

### Name: Peter Montoya Name ______

### Title President Title ______

### Exhibit A

### Initiation Fee

The Initiation Fee is normally $295, but may be reduced by providing marketing support or an enterprise purchase. Please select;

$295 Initiation. Provide no Marketing Support.

$0 Initiation Fee. Provide Full Marketing Support. 1) Representative List—Provide current list to ML.net. (Strictly bound by Non-Disclosure Agreement) for our marketing of MarketingLibrary.net. 2) Conference Calls—Conference Calls are the most effective way to educate and enroll Representatives into MarketingLibrary.net. We request one Conference Call to train Corporate Compliance & Marketing personnel and up to 5 Conference Calls to train Representatives. The number of calls is determined by demand—when demand wanes, the calls end. ML.net. will supply e-mail invitation text and host the conference calls. Broker/Dealer sends e-mails. Participation of a Compliance Officer is requested on each call. 3) Web Site—Broker/Dealers will promote MarketingLibrary.net on their websites as an approved vendor with description and link. 4) Newsletter Announcement—Broker/Dealers will issue articles or advertisements about MarketingLibrary.net in electronic or printed newsletters. 5) Flyer Distribution—A MarketingLibrary.net flyer may be distributed to Representatives by mail, or at a conferences. 6) Exhibit Booth Space & Break Out Sessions—Forty-five minute to one hour Breakout sessions will be provided free of charge at national and regional conferences. Free booth space will be provided to ML.net. at Conferences for the promotion of MarketingLibrary.net.

$0 Initiation Fee. Enterprise Purchase. Initiate MarketingLibrary.net for at least 50% of existing Representatives. Requires direct billing to Broker/Dealer Credit Card.

### Marketing Library User Agreement

Thank you for purchasing a subscription (a “Subscription”) to the MarketingLibrary.net website (the “Site”) as well as the Marketing Library internet-based software application (the “Application”) offered by MarketingLibrary.net, Inc. (“ML.net”) for use in your capacity as a financial products and services sales representative for such Broker/Dealer as you identify in your Subscription application (“Broker/Dealer”). Please read this agreement carefully before using the Site or the Application. This Marketing Library User Agreement (this “Agreement”) governs your use of the Site and the Application. By clicking the “I Agree” button below, or by accessing or using the Site or Application or any part thereof, you are acknowledging that you have read and understand this Agreement and that you agree to be bound by its terms. Additionally, your continued use of the Application will indicate your ongoing consent to be bound by the terms and conditions set forth below. This Agreement is a binding legal agreement between you (either an individual or legal entity) and ML.net If you do not agree to all of the terms in this Agreement, you should not click the “I Agree” button below, you should not access or use the Site or Application or any part thereof.

### Definitions

The following definitions shall apply to the specified terms throughout this Agreement as well as within the Site and Application:

“Message”—this term shall mean and refer to any and all marketing and business management materials for financial products and/or services obtained through the Site and Application, whether originally submitted by you for review and editing, obtained from the Site and Application's existing library of materials, provided by your Broker/Dealer through the Site and Application, or provided by a Third Party Provider through the Site and Application. Said marketing materials include, but are not limited to, postcards, e-mails, letter, flyers, invitations, presentations, brochures, contracts, facsimiles, newsletters, articles, seminars, surveys, website content, stationary, and prospectuses.
“Approved”—this term shall mean and refer to Messages that have been reviewed and approved by your Broker/Dealer for use by you and other Registered Representatives properly authorized to use the Site and Application. A Message's designation as “Approved” does not relieve you from any liability arising from the content or representations of such Message. Neither ML.net nor Broker/Dealer shall be liable for such content or representations and neither ML.net nor Broker/Dealer agrees to indemnify you against liability arising from your use of a Message designated as “Approved.”
“Approved With Changes”—this term shall apply only to those Messages submitted by you to ML.net and/or your Broker/Dealer for review and editing through the Site and Application. This term shall mean and refer to Messages approved for publication as long as certain changes specified by the compliance officer are incorporated. A Message's designation as “Approved With Changes” does not relieve you from any liability arising from the content or representations of such Message. Neither ML.net nor Broker/Dealer shall be liable for such content or representations and neither ML.net nor Broker/Dealer agrees to indemnify you against liability arising from your use of a Message designated as “Approved With Changes.”
“Broker/Dealer Library”—this term shall mean and refer to those Messages reserved for access by you and other Registered Representatives.
“Declined”—this term shall mean and refer to Messages that have been rejected by ML.net or your Broker/Dealer and may not be published by you or anyone else. You shall be solely responsible for any liability arising from your use of any Message designated as “Declined.”
“Exclusive Option”—this term shall be used exclusively in connection with Messages submitted by you to ML.net for compliance review and editing. When you elect to submit a Message to ML.net for review and editing using the Exclusive Option, said Message shall remain your sole and exclusive property. Accordingly, other users of the Site and Application, including other representatives of your Broker/Dealer will not be provided access to Messages submitted under the Exclusive Option.
“Non-Exclusive Option”—this term shall be used exclusively in connection with Messages submitted by you to ML.net for compliance review and editing. When you elect to submit a Message to ML.net for review and editing using the Non-Exclusive Option, said Message becomes the sole and exclusive property of ML.net and may be used or exploited in any manner at ML.net's sole and absolute discretion. Accordingly, such Messages may be changed as deemed necessary by ML.net and other users of the Site and Application, including without limitation other representatives of Broker/Dealer, may be provided access and permission to use such Messages at ML.net's sole and absolute discretion.
“Not Approved”—this term shall mean and refer to Messages that have not been reviewed by your Broker/Dealer and may not be published by you or anyone else. You shall be solely responsible for any liability arising from your use of any Message designated as “Not Approved.”
“Registered Representatives”—this term shall mean and refer to any sales representatives affiliated with Broker/Dealer who has been individually authorized to access and use the Site and Application through the purchase of an individual user subscription for the Site and Application and has entered into the standard “Marketing Library User Agreement.”
“Third Party Provider”—this term shall mean and refer to any provider of Messages that is not you, ML.net, or your Broker/Dealer. Such Third Party Providers may include financial product sponsors or independent marketing material content providers.
“Withdrawn”—this term shall mean and refer to Messages submitted by you to ML.net and/or your Broker/Dealer for review and editing through the Site and Application where such review and editing is cancelled at your request. You shall be solely responsible for any liability arising from your use of any Message designated as “Withdrawn.”
Additional definitions for terms used within the Site and Application may, from time to time, be provided by ML.net in its sole and absolute discretion and posted on the Site.

### Terms and Conditions

1. THE SITE AND APPLICATION. Through use of the Site and Application, you may obtain Messages for use in your capacity as a financial products and services sales representative. Messages may be obtained via the Site and Application as follows: (1) by selecting Messages posted in the general MarketingLibrary.net Message library (the “Library”); (2) if your Broker/Dealer has entered into a separate agreement with ML.net and is specifically identified under the heading “Our Broker Dealers” on the front page of the Site, by submitting a message for review and editing by your Broker/Dealer or selecting Messages from the Broker/Dealer Sub/Site's Message library; or (3) by submitting a message to ML.net for review and editing under either the Non-Exclusive or Exclusive Options. Please note that charges in addition to the Subscription Fees specified below may be incurred if you submit a Message for review and editing under either the Non-Exclusive or Exclusive Options or if you elect to use certain Third Party Provider Messages. The price for use of such services or materials shall be indicated on the Site. Such prices are subject to change from time to time at the sole and absolute discretion of ML.net or the applicable Third Party Provider, as the case may be.

A. Messages Available on Broker/Dealer Library. To the extent that your Broker/Dealer has entered into a separate agreement with ML.net and is specifically identified under the heading “Our Broker Dealers” on the front page of the Site, only those Messages to which your Broker/Dealer has consented will be available to you via the Broker/Dealer Library. Furthermore, your may control which Messages you have access to by properly categorizing you as an advisory, investment, or brokerage sales representative, as the case may be. Your Broker/Dealer bears all responsibility and liability associated with your proper categorization. Furthermore, your Broker/Dealer bears all responsibility and liability associated with the approval of specific Messages to be made available to Registered Representatives in your category. Accordingly, any and all questions or disputes regarding your individual categorization should be directed to your Broker/Dealer.

2. RESTRICTIONS ON USE. With the exception of those Messages submitted by Registered Representatives under the Exclusive Option and those Messages submitted by Third Party Providers, including Author Messages, the entire Site and Application, including but not limited to all pages within the website and any material made available for download, are the property of ML.net and/or its Broker/Dealer or Author affiliates. The Site and Application and all aspects thereof are protected by federal and international copyright and trademark laws. You shall keep intact any proprietary notices, including copyright notices, contained on any downloaded materials and shall comply with any applicable end user license agreements. Any rights not expressly granted by these Terms and Conditions or any applicable end Registered Representative license agreements are reserved by ML.net Your subscription provides the following usages:
A. A subscription to MarketingLibrary.net allows the subscribers to download documents and with those documents they may: (1) Print on your letterhead and mail to clients, prospective clients, friends, family & professional referrals; (2) Paste into an e-mail and send to clients, prospective clients, friends, family & professional referrals; (3) Post on your web site; and (4) Submit to local print publications.
B. A subscription to MarketingLibrary.net prohibits the subscribers from downloading documents or from forwarding or giving to any other Registered Representative. Additionally, each document is subject to full Intellectual Property protection. The subscriber has restricted usage rights that allow for the subscriber to use the document for their own professional use only. Should the subscriber sell or share any documents with anyone else, ML.net and/or the Author will prosecute to the fullest extent of the law Final usage terms are determined by your Broker/Dealer and are described in “Message Terms of Use.”
   3. SUBSCRIPTIONS. A. Term. The Site and Application are available only through the purchase of a Subscription. Your Subscription shall commence immediately upon ML.net's acceptance of your order to purchase that Subscription, which may precede the date on which you begin using the Site or Application. The initial term of your Subscription (the “Initial Term”) shall be one (1) year in length.

B. Automatic Renewal. Upon completion of the Initial Term, your Subscription will renew automatically on a month-to-month basis (each, a “Renewal Month”) unless you provide ML.net with notice of termination at least thirty (30) days prior to the end of the Initial Term. Any such notice must be provided to ML.net by speaking with a ML.net customer service representative at 888-730-5300 (or such other number as specified by ML.net from time to time), e-mailing support@petermontoya.com or completing the cancellation steps inherent in the system. If you provide ML.net with the appropriate termination notice prior to the end of the Initial Term, your Subscription shall continue only until the end of the Initial Term, and you shall be liable only for those fees, taxes, and other charges incurred in connection with your Subscription (collectively, “Subscription Fees”) that accrue prior to such date. After the Initial Term, you may terminate your Subscription as of the end of any Renewal Month by speaking with a ML.net customer service representative at 888-730-5300

C. Billing Information. All necessary and/or requested information must be provided at the time you submit your Subscription order. Without limitation, you must provide your full legal name, the full legal name of your Broker/Dealer, your address, telephone number(s), email address, and applicable payment data (e.g., a credit card number and expiration date) (“Member Data”). You agree to provide true, accurate and complete. Member Data and certain other information about you and/or your business are subject to our Privacy Policy. You agree and acknowledge that Member Data from the registration process is used to send you information about the Site and Application, including, but not limited to, the use of your email address for newsletters and other necessary communications. You further agree that, in the event that any Member Data changes during the course of your Subscription, you must provide updated Member Data as soon as possible. See ML.net's Privacy Statement at http://www.MarketingLibrary.net/privacy.asp for disclosures relating to ML.net's collection and use of your personal information.

D. Subscription Fees. You agree to pay all Subscription Fees without condition, delay or offset. Subscription Fees shall be as specified by ML.net from time to time in its sole discretion. ML.net may establish or change Subscription Fees for Renewal Months by posting such fees on either of the websites located at www.MarketingLibrary.net (or on a sub-page of either of those websites), by posting a conspicuous notice in the Site or Application, by emailing you, or by otherwise notifying you either orally or in writing in advance of the applicable Renewal Month. All Subscription Fees will be billed to the credit card that you designate during registration (or such other credit card as you may designate from time to time). All monthly, annual, or other periodic Subscription Fees will be billed automatically to your credit card at the start of each such period during the Initial Term. For Renewal Months, the monthly Subscription Fees will be billed to your credit card each month on the date that corresponds with the anniversary date of your Subscription. All Subscription Fees shall become nonrefundable thirty (30) days following registration. At ML.net's discretion, past due Subscription Fees are subject to interest at the rate of 1.5% per month, or the maximum permitted by law, whichever is less. You shall be responsible for all expenses (including, without limitation, reasonable attorneys' fees) incurred by ML.net in connection with the collection of any past due Subscription Fees.

4. USER NAMES AND PASSWORDS. You will be required to choose (or, at ML.net's discretion, you will be assigned) a user name and password for the Site and Application.

A. Personal Use and Confidentiality. Your user name and password are for your exclusive use. You are solely responsible for maintaining the confidentiality of your user name and password, and for all activities that occur under your user name and password. You may not disclose your user name and password to anyone other than an authorized employee of ML.net, including without limitation any other representatives or employees of the Broker/Dealer you represent. You must notify ML.net immediately if you become aware of any unauthorized use of your user name or password, or if you become aware of any other breach of security regarding the Site or Application. ML.net will not be liable for any loss or damage that you may incur as a result of someone else using your user name or password, either with or without your knowledge.

B. Record of Use. Your user name and password may be used to catalog and track your marketing activities by your Broker/Dealer. By entering into this Agreement you hereby authorize your Broker/Dealer to have access to any and all records of your usage of your account and you authorize ML.net to provide such access.

5. INTERNET ACCESS; SYSTEM REQUIREMENTS. Use of the Site and Application, or certain parts thereof, requires access to the Internet. Additionally, use of the Site and Application may require particular equipment, software, and/or telecommunications services, and ML.net may change those requirements from time to time in its sole discretion and without prior notice. You are solely responsible for obtaining, configuring, maintaining, and paying for all equipment, software, and telecommunications services necessary for you to access the Internet and use the Site and Application.
6. APPLICATION LICENSE. A. License Grant. During the term of this Agreement, and subject to all other terms and conditions herein, ML.net hereby grants you a personal, limited, revocable, nonexclusive, non-sublicensable, nontransferable license to do the following, but only for your own internal business purposes and only in a manner consistent with all applicable end user documentation: (a) use on your personal computer(s) any and all software components of the Application that ML.net makes available to you for downloading through the Site, (b) install and use on your personal computer(s) any and all software components of the Application that ML.net provides to you on physical media, and (c) access and use all components of the Application that ML.net makes available to you directly through the Site.

B. Limitations. Except as expressly permitted above in this Section 6, you may not use or reproduce the Application or the Site, including but not limited to any of the materials and Messages available via the Site and/or Application. To the maximum extent permitted by applicable law, you may not: (a) sell, sublicense, rent, lend, lease, timeshare, commercialize, or transfer the Site or Application, or otherwise make the Site or Application available, to any third party; (b) use the Site or Application for the benefit of any third party; (c) modify, translate, or create derivative works of the Site or Application; (d) reverse assemble, reverse compile, or reverse engineer the Site or Application; (e) alter or modify any disabling mechanism that may be resident in the Site or Application; (f) remove, alter, or obscure any copyright notice or other proprietary notice or legend that is on or in the Site or Application; (g) access or use the Site or Application for fraudulent purposes, in violation of any applicable laws, or in violation of this Agreement (as it may be modified from time to time). If a license to use the Site or Application was purchased in the United States, you agree to comply with all applicable United States laws and regulations pertaining to export controls. If a license to use the Site or Application was purchased outside the United States, you may not re-export the Site or Application except as permitted by the laws of the United States and the laws of the jurisdiction in which you purchased a license to use the Site or Application. Any reproduction, modification or redistribution of the Site or Application is expressly prohibited, and may result in severe civil and criminal penalties. The Site and Application, their structure, sequence and organization and source code are considered trade secrets of ML.net and are protected by trade secret laws. WITHOUT LIMITING THE FOREGOING, COPYING OR REPRODUCING THE SITE OR APPLICATION TO ANY OTHER SERVER OR LOCATION FOR FURTHER REPRODUCTION OR REDISTRIBUTION IS EXPRESSLY PROHIBITED. YOU MAY NOT DECOMPILE OR DISASSEMBLE, REVERSE ENGINEER OR OTHERWISE ATTEMPT TO DISCOVER ANY SOURCE CODE CONTAINED IN ANY SOFTWARE PROVIDED HEREUNDER.

7. LIQUIDATED DAMAGES. As noted above, your limited license to use the Site and Application is non-transferable. You and ML.net agree that, in the event that you disclose your user name and password to another person or persons and/or permit another person or persons to use the Application in violation of the terms of this Agreement it will be impracticable or extremely difficult to determine the damages suffered by ML.net It is therefore agreed that in the event of such unauthorized disclosure or use by you or by others facilitated by you, you shall pay to ML.net the sum of twenty thousand dollars ($20,000) as liquidated damages. It is hereby acknowledged and agreed that the determination of this sum is reasonable, necessary and constitutes a material part of this Agreement.
8. OWNERSHIP OF THE SITE, APPLICATION, AND MESSAGES. The Application is being licensed to you, not sold. Except for the limited license granted in Section 6 above, ML.net and its licensors own and retain all right, title, and interest in and to the Site and Application and all derivations thereof, all copies of the Application, all data, compilations, and information underlying or relating to the Application (other than any Content, as defined below), and all intellectual, industrial, and proprietary rights in or relating to any of the foregoing (including, without limitation, all copyrights, patents, trademarks, and trade secrets). Furthermore, ML.net or Third Party Vendors, as the case may be, retain all right, title, and interest in all Messages, except those Messages submitted by individual Registered Representatives under the Exclusive Option. Broker/Dealer may designate how long their Registered Representative's “Site History” (defined as the records of each Registered Representative's downloading or uploading of Messages from or to the Site) shall be maintained by ML.net Site History shall be maintained for a minimum of one (1) year, measured from the date of a given downloading or uploading event. However, Broker/Dealer may request a lengthier retention period as specified in the operative Broker/Dealer Agreement. You may receive a WORM Back-up of the General Ledger (i.e., “write once, read many”, a data storage technology that allows information to be written to a disc a single time and prevents the drive from erasing the data) of their your Site History upon request to ML.net and payment of five hundred dollars ($500) to cover costs. ML.net shall have no further obligation to retain Site History after termination of this Agreement. Accordingly, if you desire to receive a back-up of your Site History occurring prior to such termination, a back-up must be requested pursuant to this section concurrently with the termination of this Agreement.
9. USER CONTENT. A. Representations. You are solely responsible for any and all data, diagrams, pictures, text, information, and other materials that you input, store, or transmit using the Application (collectively, your “Content”). You hereby represent and warrant to ML.net that your Content will not: (a) infringe upon or otherwise violate any intellectual or industrial property rights (including, without limitation, copyrights, patent rights, trademark rights, and trade secret rights), or any other rights (such as the rights of privacy and publicity), of any third party; (b) contain any software viruses or other computer code, files, or programs designed to interrupt, destroy, or limit the functionality of any equipment, software, or telecommunications services; (c) contain any unlawful, harassing, harmful, threatening, profane, defamatory, or obscene materials; or (d) violate any applicable laws.

B. Storage. You may store your Content on ML.net's servers for use with the Application, and ML.net will use commercially reasonable efforts to backup such Content at least one time per week. However, you acknowledge and agree that ML.net has no responsibility or liability for any deletion, destruction, corruption, or other loss of such Content. ML.net may, from time to time, set limits on the amount of disk space allotted to you for the storage of your Content on ML.net's servers. Further, ML.net may charge storage fees for exceeding those limits. You will be notified of any such limits and storage fees (or any changes thereto) through email, through a notice posted in a conspicuous place in the Application, through a notice posted on either of the websites located at www.MarketingLibrary.net (or on a sub-page of this website), or through some other form of notice provided either orally or in writing.

10. TECHNICAL SUPPORT. ML.net will, to the extent commercially reasonable, attempt to assist you with accessing and using the Application (“Technical Support”). ML.net will, at your option, provide you with Technical Support via telephone, facsimile, and/or email. Technical Support staff is available between the hours of 9:00 AM and 5:00 PM, Pacific Standard Time, Monday through Friday. However, Technical Support response times may vary depending upon the nature of the support requested and the quantity of other support requests. ML.net may modify its Technical Support policies and procedures (including, without limitation, availability dates and times and communication methods) from time to time in its sole discretion and without notice. For further information regarding Technical Support, please visit ML.net's website at www.MarketingLibrary.net.
11. MAINTENANCE. ML.net will use commercially reasonable efforts to promptly repair faults in the Application that materially degrade its functionality or performance, or that cause it to be inaccessible to users. ML.net may also perform other maintenance on the Application from time to time in its sole discretion. You shall not be entitled to any abatement in Subscription Fees for any Application faults or downtime.
12. MODIFICATIONS. ML.net may upgrade, enhance, change, suspend, discontinue, or otherwise modify any aspects or components of the Application (collectively, “Modifications”) at any time in its sole and absolute discretion and without notice. Any Modifications made available to you will be subject to the terms of this Agreement. You shall not be entitled to any abatement in Subscription Fees for any Modifications.
13. SUSPENSION; TERMINATION. If ML.net believes, in its sole discretion, that you have violated any term or condition in this Agreement, ML.net may suspend your access to and use of the Application until such time as ML.net believes, in its sole discretion, that you have cured such violation or that such violation did not occur. Any such suspension shall not entitle you to any abatement in Subscription Fees. If you breach or otherwise fail to comply with any of the terms or conditions in this Agreement, ML.net may terminate your Subscription immediately and without notice, and you shall not be entitled to a refund of any pre-paid Subscription Fees. ML.net may also terminate your Subscription for any reason or no reason whatsoever upon thirty (30) days prior notice via email or otherwise in writing, in which event you shall receive a prorated refund of any prepaid, periodic Subscription Fees (such proration to be calculated using the date on which the Agreement terminated). You may terminate your Subscription by written notice to ML.net if ML.net materially breaches this Agreement and fails to cure such breach within thirty (30) days following receipt of written notice from you describing the breach in reasonable detail. If you terminate your Subscription due to a material breach by ML.net, you shall be entitled to a prorated refund of any prepaid, periodic Subscription Fees (such proration to be calculated using the date on which the Agreement terminated). You acknowledge that as of Feb. 1, 2006 and from time to time thereafter there may be certain specialized versions of the Application to which You may have been or may be given access, delivery and/or rights of use, and that such specialized versions may include, without limitation, co-branding by ML.net and another party or organization (e.g., a Broker/Dealer or Registered Investment Advisory company) due to a business relationship between them (collectively, “Special-issue” or “Co-Branded Products”). For those entering into this Agreement on or after Feb. 1, 2006, You agree that ML.net shall have the right, in its sole discretion, without notice to You and without limiting any other right or action herein reserved to ML.net, to (i) discontinue, cease support of and terminate Your access to and use of any such Special-Issue or Co-Branded Product(s), and (ii) transition You (provided You are then in good standing and not in breach of this Agreement) to a then-available product offered by ML.net as an alternative to such Special-Issue or Co-Branded Product. Upon any expiration or termination of your Subscription, (a) this Agreement shall automatically and immediately terminate, (b) you will no longer be allowed to access and use the Application, (c) you must remove all copies of the Application, or any components thereof, from your personal computer(s) and destroy any and all related media and documentation, (d) you shall remain liable for all Subscription Fees that have accrued but remain unpaid as of the date of such expiration or termination, and (e) Sections 2, 4, 7, 8, 9, 13, 15, 16, 17, 18, 19, 20, and 21 of this Agreement shall survive and shall remain in full force and effect in perpetuity. Ninety (90) days following any expiration or termination of your Subscription, ML.net may delete any or all of your Content that is stored on any ML.net servers. YOU ACKNOWLEDGE AND AGREE THAT THE APPLICATION MAY HAVE A MECHANISM WHEREBY ML.net CAN LIMIT OR DISABLE YOUR ACCESS TO THE APPLICATION. YOU AGREE THAT ML.net MAY USE SUCH MECHANISM UPON ANY EXPIRATION OR TERMINATION OF YOUR SUBSCRIPTION, OR IF ML.net SUSPENDS YOUR ACCESS TO OR USE OF THE APPLICATION AS PERMITTED IN THIS SECTION 13.
14. ADVERTISING ON THE SITE. ML.net may, in its sole and absolute discretion, place its own advertising as well as advertising of third parties on any portion of the Site. Such advertising may include, without limitation, pop-ups, landing pages, banners, and crawlers. Third party advertising appearing in any area of the Broker/Dealer Library shall be approved by your Broker/Dealer.
15. THIRD PARTY CONTENT. The Site contains content and information from Third Party Providers and/or links to third party Web sites, including but not limited to advertising (“Third Party Content”). Such content is not under the control of ML.net and ML.net is not responsible for such content, including, without limitation, any link contained in such content, or any changes or updates to such content. ML.net is providing such Third Party Content to you only as a convenience, and the inclusion of such content does not imply endorsement by ML.net of such content or the affiliate. You may be subject to additional and/or different terms, conditions, and privacy policies when you use third party services, content, software, or sites. ML.net does reserve the right to remove content that, in ML.net's judgment, does not meet its standards, but ML.net is not responsible for any failure or delay in removing such material. ML.net is not and will not be responsible for (i) the terms and conditions of any transaction between you and any third party, (ii) any insufficiency of or problems with any such third party's background, insurance, credit or licensing, or (iii) the quality of services performed by any such third party or any other legal liability arising out of or related to the performance of such services. In the event that you have a dispute with any such third party, you release ML.net (and its affiliates, suppliers, agents and employees) from any and all claims, demands and damages (actual and consequential) of every kind and nature, known and unknown, suspected and unsuspected, disclosed and undisclosed, arising out of or in any way connected with such disputes. Messages generated by Third Party Providers may be made available through the Site and Application subject to this Section 15. Such Messages are the property of the corresponding provider. Accordingly, your use of such Messages may be subject to additional or different licenses than those specified herein and may be subject to additional fee not included in the Subscription Fees specified in Section 3 herein. When a Representative purchases or downloads any Third Party Content, the Representative name and contact information will be supplied to the Third Party. The Third Party may contact the Representative by phone, email or mail.
16. NO REPRESENTATIONS OR WARRANTIES. The Site and Application are provided on an “as available,” “as is” basis. To the maximum extent permitted by applicable law, ML.net and its parent companies, subsidiaries, affiliates, suppliers, and licensors disclaim all representations and warranties of any kind with respect to the Site, Application, and any Messages, including but not limited to implied warranties of non-infringement, title, merchantability, quiet enjoyment, quality of information, and fitness for a particular purpose. Without limiting the generality of the foregoing: ML.net does not represent or warrant that the Site, the Application, or the Messages will meet your requirements, that the operation of the Site or Application will be uninterrupted or error-free, or that defects in the Site, the Application, the Messages or related documentation will be corrected. ML.net makes no representation or warranty of any kind, express or implied, as to the speed, operation, or reliability of the Site or Application, the accuracy or completeness of any information accessible via the Site or Application, or the availability, quality, or safety of Messages or any other products or services available through the Site or Application. Further, ML.net does not represent or warrant that the Site or Application, or the content available through the Site or Application, are free of viruses or other harmful components. No oral or written information or advice given to you or your agent by ML.net or any other party with respect to the Site or Application or anything related thereto shall create a representation or warranty, or in any way increase the scope of ML.net's obligations hereunder. ML.net assumes no responsibility and makes no representations, warranties, recommendations, endorsements, or approvals with regard to any Messages, opinions, advice, statements, products, services, offers, or other information or materials expressed or made available by third parties, including but not limited to Third Party Providers, through or in connection with the Site or Application. You assume total responsibility and risk for your use of the Site, the Application, and any and all Messages and related services.
17. LIMITATIONS ON LIABILITY. TO THE MAXIMUM EXTENT PERMITTED BY APPLICABLE LAW, IN NO EVENT SHALL ML.NET OR ITS PARENT COMPANY, SUBSIDIARIES, AFFILIATES, SUPPLIERS, OR LICENSORS BE LIABLE FOR ANY DAMAGES WHATSOEVER, WHETHER DIRECT, INDIRECT, PUNITIVE, EXEMPLARY, SPECIAL, INCIDENTAL, CONSEQUENTIAL, OR OTHER DAMAGES (INCLUDING, WITHOUT LIMITATION, DAMAGES FOR PERSONAL INJURY, LOST PROFITS, LOST DATA, AND/OR BUSINESS INTERRUPTION), ARISING OUT OF OR RELATING IN ANY WAY TO THE USE OR INABILITY TO USE THE SITE OR APPLICATION, AN RELATED SERVICES, OR ANY CONTENT OR INFORMATION CONTAINED THEREIN EVEN IF ML.NET OR ANY SUCH RELATED PARTY HAS BEEN ADVISED OF THE POSSIBILITY OF SUCH DAMAGES. IN ANY CASE, ML.NET'S ENTIRE LIABILITY UNDER THIS AGREEMENT SHALL BE LIMITED TO THE AGGREGATE SUBSCRIPTION FEES PAID BY YOU DURING THE IMMEDIATELY PRECEDING TWELVE (12) MONTH PERIOD. YOU AGREE THAT YOU WILL HAVE SOLE AND COMPLETE RESPONSIBILITY FOR ANY DECISIONS MADE OR ACTIONS TAKEN BY YOU IN RELIANCE UPON THE SITE OR APPLICATION. YOU ACKNOWLEDGE AND AGREE THAT THE SITE AND APPLICATION ARE NOT INTENDED TO SUPPLY TAX, INVESTMENT, OR LEGAL ADVICE. IT IS EXPRESSLY UNDERSTOOD AND AGREED THAT IN THE EVENT ANY REMEDY HEREUNDER IS DETERMINED TO HAVE FAILED OF ITS ESSENTIAL PURPOSE, ALL LIMITATIONS OF LIABILITY AND EXCLUSIONS OF DAMAGES SET FORTH HEREIN SHALL REMAIN IN EFFECT.
18. INDEMNIFICATION. You agree to indemnify, defend, and hold harmless ML.net, its employees, members, directors, managers, officers or agents from and against any loss, liability, damage, penalty or expense (including attorneys' fees, expert witness fees and cost of defense) they may suffer or incur as a result of (i) any failure by you or any employee or agent of you to comply with the terms of this Agreement; (ii) any warranty or representation made by you being false or misleading; (iii) any representation or warranty made by you or any employee or agent of you to any third person other than as specifically authorized by this Agreement, (iv) negligence of you or your subcontractors, agents or employees, or (v) any alleged or actual violations by you or your subcontractors, employees or agents of any governmental laws, regulations or rules.
19. U.S. GOVERNMENT RESTRICTED RIGHTS. The Application and any related documentation are provided with RESTRICTED RIGHTS. Use, duplication, or disclosure by the United States Government is subject to restrictions as set forth in subparagraph (c)(1)(ii) of the Rights in Technical Data and Computer Software clause at DFARS 252.227-7013 or subparagraphs (a) through (d) of the Commercial Computer Software—Restricted Rights at 48 CFR 52.227-19, and in similar clauses in the NASA FAR Supplement, as applicable. Manufacturer is ML.net, 150 El Camino Real, Ste. 200, Tustin, Ca, 92780, USA.
20. ARBITRATION. Any and all disputes, controversies, or claims arising out of or relating to this Agreement, including without limitation, claims based on contract, tort, or statute, shall be determined by binding arbitration by the American Arbitration Association. The parties shall have the right to conduct discovery pursuant to the California Code of Civil Procedure. The arbitration shall be venued in Orange County, Calif. This Agreement to arbitrate is intended to be binding on and to inure to the benefit of the parties to this Agreement, their principals, successors, assigns, affiliates, partners, employees, parent or subsidiary entities, and to any other parties whose claims or defenses may arise out of or relate to this agreement. The prevailing party shall be entitled to recover its reasonable attorney fees, expert fees, and costs. Judgment on the award rendered by the arbitrator may be entered in any court having jurisdiction.
21. MISCELLANEOUS. This Agreement constitutes the entire understanding and agreement between ML.net and you with respect to the subject matter hereof, and supersedes all prior or contemporaneous oral or written communications with respect to the subject matter hereof, all of which are merged herein. This Agreement is governed by and construed in accordance with the laws of the State of California, U.S.A, as applied to agreements entered into and wholly performed within California between California residents. Any action or proceeding arising from or relating to this Agreement that is brought by either party hereto shall be brought only in a state or federal court of competent jurisdiction located in the County of Orange, State of California, U.S.A., and the parties hereby submit to the personal jurisdiction of such courts for purposes of any such action or proceeding. In any action arising from this Agreement, the prevailing party shall be entitled to recover its costs, including expert witness fees, and attorney's fees from the other party. THIS AGREEMENT SHALL NOT BE GOVERNED BY THE 1980 U.N. CONVENTION ON CONTRACTS FOR THE INTERNATIONAL SALE OF GOODS. In the event that any provision of this Agreement is found invalid or unenforceable pursuant to judicial decree, the remainder of this Agreement shall remain valid and enforceable according to its terms. Any failure by ML.net to strictly enforce any provision of this Agreement will not operate as a waiver of that provision or any subsequent breach of that provision. ML.net shall not be responsible for any delays, errors, failures to perform, interruptions, or disruptions in the Application caused by any acts of God, strikes, lockouts, riots, acts of war, changes in law or regulations, fire, flood, earthquake, storm, power failure, or failures of the Internet. Any notices from ML.net under this Agreement that are sent by email, or that are posted in the Application or on ML.net's website at www.MarketingLibrary.net (or on a sub-page thereof), shall be deemed given when sent or posted, as applicable. You will not use the Site for any purpose that is unlawful or prohibited by this Agreement or by applicable laws or regulations.
22. MODIFICATIONS TO TERMS OF USE. ML.net may modify the terms of use for the Site and Application from time to time in its sole discretion. ML.net will notify you of any such modifications by email, by posting a conspicuous notice in the Application, or otherwise in writing (each, a “Modification Notice”). You must contact ML.net immediately following your receipt of a Modification Notice if you do not agree to such modifications. By continuing to use the Application or any aspect or component thereof after ML.net sends or posts (as applicable) a Modification Notice, you are agreeing to such modifications.

1. A method of providing over a computer network marketing material concerning securities to authorized users, said method comprising
(a) providing a website on the computer network that an authorized user can access,
said website including an electronic library containing marketing material that is in compliance with regulations governing securities brokers/dealers and their Registered Representatives and that is downloadable over the computer network by an authorized user for copying and distribution by said individual authorized user, and
(b) tracking data concerning the marketing material to enable reporting in compliance with regulations governing securities Brokers/Dealers and their Registered Representatives.

2. The method of claim 1 where the marketing material is identified for distribution to a limited number of selected, individual authorized users.

3. The method of claim 1 where the marketing material is identified for distribution to anyone who is an authorized user

4. The method of claim 1 where an individual authorized user who is a Registered Representative and a compliance officer of such representative's registered Broker/Dealer who is an authorized user are in communication for reviewing marketing material for approval by said compliance officer prior to placing in the electronic library.

5. The method of claim 4 where said Registered Representative uploads to the website unapproved marketing material for review and approval by said compliance officer, and said compliance officer uploads to the website for storage in the electronic library approved marketing material submitted by said Registered Representative or others.

6. The method of claim 1 where the marketing material stored in the electronic library is in a write once read many times form.

7. The method of claim 1 where a program operates the website to track data and on demand prepare a report based on the tracked data that is suitable for submission in compliance with regulations governing securities Brokers/Dealers and their Registered Representatives.

8. The method of claim 7 where the program identifies (i) each individual item of approved marketing material stored in the library and when a copy of each such item is downloaded, (ii) the authorized user downloading each copy of such item, (iii) the source approving the content of each such item, (iv) the date of approval of each such item, (v) the nature of the contents of each such item, and (vi) when a Registered Representative who is an authorized user downloads a copy of any such individual item, that representative's registered Broker/Dealer who is also an authorized user.

9. The method of claim 6 where the report is an electronic report downloadable from the website over the network.

10. The method of claim 1 where an authorized Registered Representative can over the network submit for approval by uploading to the website an unapproved item of marketing material that is in electronic form and downloadable from the website for review and approval, and subsequently uploaded to the website after approval.

11. A method of providing marketing material concerning securities to authorized users, said method comprising
(a) providing a website on a global computer network that an authorized user can access over said network,
said website including an electronic library containing electronic marketing material approved by a compliance officer of an authorized registered Broker/Dealer and stored in a write once read many times form, and downloadable over said network by an authorized user accessing the website, and
(b) electronically tracking of data concerning the marketing material in the electronic library to enable reporting in compliance with regulations governing securities brokers/dealers and their Registered Representatives, and
(c) on demand by accessing the website and downloadable from the website confirmation to authorized users that distribution of the marketing material through the website is in compliance with regulations governing securities Brokers/Dealers and their Registered Representatives.

12. The method of claim 11 where an individual authorized user who is a Registered Representative and a compliance officer of such representative's registered Broker/Dealer who is an authorized user are in communication for reviewing marketing material for approval by said compliance officer prior to placing in the electronic library.

13. The method of claim 12 where said Registered Representative uploads to the website unapproved marketing material for review and approval by said compliance officer, and said compliance officer uploads to the website for storage in the electronic library approved marketing material submitted by said Registered Representative or others.

14. A system for providing marketing material concerning securities comprising
a computer network,
a website on the computer network accessible over the network by an authorized user,
said website including an electronic library containing a plurality of individual items of approved marketing material of different content stored in a memory of a server in the network in a write once read many times electronic form,
a program that operates the website (a) to track electronically data concerning the marketing material to enable reporting in compliance with regulations governing securities Brokers/Dealers and their Registered Representatives and (b) to confirm to authorized users that distribution of the marketing material through the website is in compliance with regulations governing securities Brokers/Dealers and their Registered Representatives,
a computer system connected to the computer network that enables an authorized user to access the marketing material and reports,
a computer system connected to the computer network that enables an authorized user to access the marketing material and reports.

15. The system of claim 14 where the program identifies (i) each individual item of approved marketing material stored in the library and when a copy of each such item is downloaded, (ii) the authorized user downloading each copy of such item, (iii) the source approving the content of each such item, (iv) the date of approval of each such item, (v) the nature of the contents of each such item, and (vi) when a Registered Representative who is an authorized user downloads a copy of any such individual item, that representative's registered Broker/Dealer who is also an authorized user.

16. The system of claim 14 including means for enabling an individual authorized user who is a Registered Representative and a compliance officer of such representative's registered Broker/Dealer who is an authorized user to give notice via E-mail concerning review of marketing material for approval by said compliance officer prior to placing in the electronic library.

17. The system of claim 16 where said enabling means allows said Registered Representative to upload to the website unapproved marketing material for review and approval by said compliance officer, and allows said compliance officer to upload to the website for storage in the electronic library approved marketing material submitted by said Registered Representative or others.

18. A website on a computer network that only an authorized user can access, said website including
an electronic library containing marketing material concerning securities approved as in compliance with laws governing the sale of securities, and
means for tracking of data concerning the marketing material to enable reporting in compliance with regulations governing securities brokers/dealers and their Registered Representatives.

19. The website of claim 18 where the website is operated by a program that identifies (i) each individual item of approved marketing material stored in the library and when a copy of each such item is downloaded, (ii) the authorized user downloading each copy of such item, (iii) the source approving the content of each such item, (iv) the date of approval of each such item, (v) the nature of the contents of each such item, and (vi) when a Registered Representative who is an authorized user downloads a copy of any such individual item, that representative's registered Broker/Dealer who is also an authorized user.

20. The website of claim 18 including means for enabling an individual authorized user who is a Registered Representative and a compliance officer of such representative's registered Broker/Dealer who is an authorized user to give notice via E-mail concerning review of marketing material for approval by said compliance officer prior to placing in the electronic library.

21. The system of claim 20 where said enabling means allows said Registered Representative to upload to the website unapproved marketing material for review and approval by said compliance officer, and allows said compliance officer to upload to the website for storage in the electronic library approved marketing material submitted by said Registered Representative or others.

22. A method of selling access to, including the right to copy and distribute, marketing material concerning securities, said method comprising
providing on a computer network a website having an electronic library containing marketing material concerning securities that has been pre-approved as in compliance with regulations governing the sale of securities and is downloadable over the computer network by an authorized user,
said website having a domain name and domain name owner, with said domain name owner having the legal right to control who has access to the marketing material the over the network and to download, copy and distribute said marketing material, and
entering into a legally binding agreement over the network with a legally competent party who purchases the right to become an authorized user who can access said approved marketing material over the network in the electronic library by using an identifying access code.

23. The method of claim 22 where a program operates the website to track data and on demand prepare a report based on the tracked data that is suitable for submission in compliance with regulations governing securities Brokers/Dealers and their Registered Representatives.

24. The method of claim 23 where the program identifies (i) each individual item of approved marketing material stored in the library and when a copy of each such item is downloaded, (ii) the authorized user downloading each copy of such item, (iii) the source approving the content of each such item, (iv) the date of approval of each such item, (v) the nature of the contents of each such item, and (vi) when a Registered Representative who is an authorized user downloads a copy of any such individual item, that representative's registered Broker/Dealer who is also an authorized user.

25. The method of claim 22 where an outside author submits marketing material for approval via the website and when such approved outside author marketing material is downloaded, the outside author is compensated financially.
